(19) United States
(12) Patent Application Publication
(10) Pub. No.: US 2026/0054839 A1
(43) Pub. Date: Feb. 26, 2026

(54) ENERGY ATTENUATION SYSTEM

(71) Applicant: Israel Aerospace Industries Ltd., Lod (IL)

(72) Inventors: Simon SAGIV, Lod (IL); Oleksiy SOKOLSKYY, Lod (IL)

(21) Appl. No.: 19/099,916

(22) PCT Filed: Jul. 30, 2023
(86) PCT No.: PCT/IL2023/050783

§ 371 Date: Jan. 30, 2025

(30) Foreign Application Priority Data
Aug. 4, 2022 (IL) 295375

(51) Int. Cl. B64D 11/06; B60N 2/42

(52) U.S. Cl. CPC B64D 11/0619; B60N 2/4242

(57) ABSTRACT

An energy attenuation system for a seating system (having a bucket and a frame includes at least one energy attenuation component operatively coupled with a fuse system. The energy attenuation component includes first and second ends securable to the bucket and the frame, respectively. The fuse system includes a plurality of fuse elements and an engagement element. Each fuse element has a first and second fuse ends, and operates to break under a corresponding predetermined fixed load. The engagement element is movable with respect to the fuse elements and is engageable in a load bearing manner via the respective said second fuse ends thereof with any desired fuse element group chosen, each fuse element group including one or more fuse elements. The engagement element is securable to the bucket or the frame, and the first fuse ends of all the fuse elements are securable to the frame or bucket, respectively.

### TECHNOLOGICAL FIELD

The presently disclosed subject matter relates to energy attenuation systems, in particular for use in attenuation of energies associated with high energy impact events.

### BACKGROUND

High acceleration forces are generated in a so-called high energy impact event, for example an under-vehicle explosion or an air vehicle slam down such as a helicopter crash landing. In the absence of appropriate energy attenuation systems for personnel that are located in such vehicles during such a high energy impact event, the spinal column loading can exceed safety limits and cause injury or death to such personnel.

Conventional energy attenuation systems are provided in civilian and military aircraft such as helicopters, for example, are provided in the personal seating arrangements, and operate to absorb or attenuate the impact energy as a function of the displacement (stroke) of the seat or bucket, relative to the stationary seat support or base. However, the safety limits for spinal column loading can vary according to the weight of the seat occupant, for example from a 95^{th} percentile male (about 222.3 lbs (100.8 Kg), as defined in JSSG-2010-7 for a pilot) to a 5^{th} percentile female (about 113.4 lbs (51.44 Kg) as defined in JSSG-2010-7, for a pilot).

For a given energy attenuation capacity and stroke that is designed for the 5^{th} percentile female, such a stroke can be too short for a heavy occupant (for example, a 95^{th} percentile male), who can be injured, since the seat will come into contact with the vehicle floor very soon and prevent further energy attenuation.

On the other hand, if the energy attenuation capacity and stroke is designed for the 95^{th} percentile male, the energy attenuation characteristics will be too stiff for a lighter occupant (for example, a 5^{th} percentile female), and the acceleration applied to such a lighter occupant will not be sufficiently absorbed. In such cases the lumbar loads experienced by the lighter occupant will be much than allowed for such an occupant, which can lead to serious injury. Furthermore, depending on the weight of the lighter occupant, it is possible that the low weight of the occupant will be insufficient to even initiate operation of the energy attenuation system, and thus the damping process will be not even start or can be very short.

Conventionally, energy attenuation capacity and stroke in civil applications are designed for the 50^{th} percentile male, having a weight of about 170 lbs (77.1 kg).

By way of non-limiting example, U.S. Pat. No. 11,066,172 discloses controlled energy absorption of seats for impact. One disclosed example method includes determining a weight of an occupant of a seat of an aircraft, and calculating, using a processor, a stroke load of a seat energy absorber operatively coupled to the seat based on the weight of the occupant. The example method also includes setting the seat energy absorber to the calculated stroke load.

Also by way of non-limiting example, CN110803287 discloses a light variable load seat energy absorption device. A steel wire, a wire bending assembly, connecting assemblies and a shearing piece are included. The steel wire is a vertical energy absorption component. The wire bending assembly is connected with a movable part of a seat, the steel wire penetrates through a shell of the wire bending assembly, and a bending section is arranged at the part in the shell. Guiding wheels and an adjusting mechanism are arranged on the shell of the wire bending assembly, and the guiding wheels are located at the two ends of the steel wire bending section and clamped on the two sides of the steel wire. The adjusting mechanism comprises a supporting wheel jacking a steel wire bending section groove, and the adjusting mechanism can adjust the ejection distance of the supporting wheel so that the bending degree of the steel wire bending section can be adjusted. The two connecting assemblies are connected and fixed to a fixed part of the seat and connected and fixed to the two ends of the steel wire correspondingly. The shearing piece is connected and fixed to the connecting assembly at the upper portion and the wire bending assembly at the same time, and when the impact acceleration exceeds a certain degree, the shearing piece is fractured. The device is reliable in start, has the variable load function and is small in weight, low in cost and wide in application range.

Also by way of non-limiting example, U.S. Pat. No. 9,399,518 discloses an energy absorber to limit an acceleration force experienced by a heavy body, such as an occupant of a seat subjected to the acceleration of an aircraft crash, comprises a winding drum mounted in rotation around a shaft, around which a traction line is wound. The shaft is coupled mechanically to a brake that immobilizes the shaft in rotation when a torque applied to the shaft by the traction line is less than the maximum brake torque that can be generated by the brake and that when the shaft is in rotation generates a torque that is approximately constant and equal to the maximum brake torque. A control element acting on the brake makes it possible to modify the value of the maximum brake torque and thus to adapt the energy absorber to the mass of the heavy body to maintain an acceleration experienced at a desired value for different masses.

Also by way of non-limiting example, U.S. Pat. No. 10,052,984 discloses methods and apparatus for an energy attenuation vehicle seating system that includes a seat configured for guided motion relative to a vehicle compartment over a stroking distance, and an energy attenuation component with a first end attached to the seat, a second end configured for attachment to the vehicle compartment, and an intermediate point configured for guided motion relative to the vehicle compartment. The energy attenuation component is configured to remain rigid and prevent the seat from moving under loads less than a predetermined threshold value, yet deform in a progressive, predictable manner in response to a load exceeding the threshold.

Also by way of non-limiting example, U.S. Pat. No. 9,382,008 discloses a seat comprising a bucket and a frame fastened to a floor. Said seat includes at least one energy absorber system having a plurality of energy absorbers arranged in parallel. Said seat includes an index that is movable in translation to secure the bucket to an energy absorber system by engaging with one end of one or more energy absorbers. Said seat includes at least one suspension system having a spring member suspending said bucket from said frame as a function of the weight of a passenger, mechanical indexing means co-operating with an index, said seat including a mechanical inhibitor system for blocking the suspension system during a crash.

Also by way of non-limiting example, U.S. Pat. No. 8,087,723 discloses a crashworthy seat for a vehicle comprises a stand including a first and a second foot connected mechanically to a first and a second vertical support leg; a pan connected by the stand to a floor wherein the first and the second feet are disposed on each side of the pan, the pan including a seat proper and a seat back, wherein the seat back has a support element secured to the first and the second vertical support legs configured to support the seat back a guide element configured to guide the pan in translation; an energy absorber device; a first anchor point secured to the first distal end of the absorber portion; and a second anchor point secured to the second distal end of the absorber portion.

Also by way of non-limiting example, U.S. Pat. No. 8,342,300 discloses an energy absorber device for damping the movements of a load support relative to a stationary base, said load support being connected to the stationary base via a hydromechanical connection. The device comprises automatic and self-contained setting means serving firstly to adapt under static conditions to the weight of the loads supported by the support, and secondly under dynamic conditions, e.g., in the event of a sudden movement of the crash type, to subject the subassembly comprising the support and the loads to acceleration or deceleration values that are below a threshold value.

Also by way of non-limiting example, U.S. Pat. No. 8,408,643 discloses a seat for a powered aircraft, the seat comprising a bucket that is supported in hyperstatic manner on a stand. Leg members carry the bucket via bolts. A first hinged mechanism for geometrically compensating deformation of the floor associates a ball-joint mounting of the bolts on the leg members with an axial deformation arrangement of the bolts between opposing axial bearing surfaces where they press against a strength member of the bucket and against the leg members. A second energy-absorber mechanism associates fuses with deformable support members for the bucket, which members engage the bolts and the leg members via slides arranged to adjust the initial height position of the bucket.

Also by way of non-limiting example, GB 1,077,322 discloses a helicopter seat is fitted with an energy absorbing device which renders under sudden vertical shock to allow the seat to descend along guides. The seat member provides an anchorage for one end of a nylon netting hammock seat which extends to an adjustable, ratchet controlled, roller.

### General Description

According to a first aspect of the presently disclosed subject matter there is provided an energy attenuation system for a seating system having a bucket and a frame, the energy attenuation system comprising at least one energy attenuation component operatively coupled with a fuse system, wherein:
the at least one energy attenuation component is configured for attenuating energy during a high energy impact event, each said energy attenuation component comprising a respective first energy attenuation component end configured for being secured to the bucket, and a respective second energy attenuation component end configured for being secured to the frame;
the fuse system comprises a plurality of fuse elements and an engagement element, wherein;
   each said fuse element is configured for breaking under a corresponding predetermined fixed load;
   each said fuse element comprises a respective first fuse end and a respective second fuse end;
   the engagement element is movable with respect to the fuse elements and thereby selectively engageable in a load bearing manner with any desired fuse element group chosen from at least two said fuse element groups, wherein each said fuse element group comprises one or more said fuse elements, and wherein the engagement element is engageable in a load bearing manner with the one or more fuse elements of the desired fuse element group via the respective said second fuse ends thereof;
   the engagement element is configured for being secured to one of the bucket and the frame, and the respective said first fuse ends of all the fuse elements are configured for being secured to the other one of the bucket and the frame.

For example, the at least one energy attenuation component is configured for attenuating energy during a high energy impact event subsequent to the respective fuse element group, that is engaged with the engagement element, breaks.

Additionally or alternatively, for example, each said fuse element group, together with said at least one energy attenuation component, are together configured for providing, during a high energy impact event, a respective lumbar load to an occupant of the seating system that is not greater than a predetermined threshold lumbar load limit corresponding to a weight of the occupant. For example, said predetermined threshold lumbar load limit corresponds to a safety limit for the occupant. Additionally or alternatively, for example, said predetermined threshold lumbar load limit increases as a weight of the occupant increases.

Additionally or alternatively, for example, each said fuse element group has a respective operating fuse load rating corresponding to a summation of the fixed loads of the specific fuse elements that are included in the respective said fuse group. For example, the energy attenuation system is configured for use with each one, in turn, of a plurality of said occupants including a minimum-weight said occupant and a maximum-weight said occupant, and including at least a first said fuse element group corresponding to said minimum-weight occupant, and a second said fuse element group corresponding to the maximum-weight occupant.

Additionally or alternatively, for example, the energy attenuation system is configured for extending a time period at which the respective said lumbar load is close to the respective said threshold lumbar load limit, while not exceeding the respective said threshold lumbar load limit.

Additionally or alternatively, for example, one said operating fuse load rating corresponds to a 5^{th} percentile female.

Additionally or alternatively, for example, one said operating fuse load rating corresponds to a 50^{th} percentile male.

Additionally or alternatively, for example, one said operating fuse load rating corresponds to a 95^{th} percentile male.

Additionally or alternatively, for example, one said operating fuse load rating corresponds to a first range between a 5^{th} percentile female and a 50^{th} percentile male.

Additionally or alternatively, for example, one said operating fuse load rating corresponds to a second range between a 50^{th} percentile male and a 95^{th} percentile male.

Additionally or alternatively, for example, the energy attenuation system comprises a plurality of operating fuse ratings, wherein each said operating fuse load rating corresponds to a different range of weights between a 5^{th} percentile female and a 95^{th} percentile male. For example, a first said range of weights corresponds to a range between 5^{th} percentile female and a 50^{th} percentile male, and wherein a second said range of weights corresponds to a range between 50^{th} percentile male and a 95^{th} percentile male. Alternatively, for example, a first said range of weights corresponds to a range between 5^{th} percentile female and a 40^{th} percentile male, wherein a second said range of weights corresponds to a range between 40^{th} percentile male and a 60^{th} percentile male, and wherein a third said range of weights corresponds to a range between 60^{th} percentile male and a 95^{th} percentile male.

Additionally or alternatively, for example, one said operating fuse load rating corresponds to a first range between a 5^{th} percentile female and a 50^{th} percentile male.

Additionally or alternatively, for example, one said operating fuse load rating corresponds to a second range between a 50^{th} percentile male and a 95^{th} percentile male. Additionally or alternatively, for example, the fuse system has a respective said operating fuse load rating that corresponds to the summation of the fixed loads of the specific fuse elements that are engaged to the bucket and the stationary base via the engagement element.

Additionally or alternatively, for example, the engagement element is movable between a plurality of successive positions, including a retracted position and an extended position via a plurality of intermediate positions, wherein in the retracted position the engagement element is not engaged with any said fuse elements, wherein in the extended position the engagement element is engaged with all said fuse elements, and wherein each said intermediate position comprises one said fuse element group, and wherein in each successive intermediate position from the retracted position to the extended position the engagement element is engaged with an increasing number of said fuse elements.

For example, said engagement element comprises a rod member having a free first longitudinal end, and a second longitudinal end that carries a graspable knob, wherein said rod member is movably mounted to the bucket. For example, the second fuse ends of the fuse elements each comprise a respective lumen, and wherein said lumens are serially and co-axially aligned with one another along an engagement axis. For example, said lumens have respective cross-sections having a size and shape complementary to a cross-section of the rod member, such that when the rod member passes through each said lumen load bearing contact is established between the respective lumen and the rod member.

Additionally or alternatively, for example, at a first said position, the respective said operating fuse load rating corresponds to a 5^{th} percentile female, wherein at a second said position the respective said operating fuse load rating corresponds to a 50^{th} percentile male, and wherein at a third said position the respective said operating fuse load rating corresponds to a 95^{th} percentile male.

Alternatively, for example, at a first said position, the respective said operating fuse load rating corresponds to a first range between a 5^{th} percentile female and a 95^{th} percentile male, wherein at a second said position the respective said operating fuse load rating corresponds to a second range between a 5^{th} percentile female and a 95^{th} percentile male, and wherein at a third said position the respective said operating fuse load rating corresponds to a third range between a 5^{th} percentile female and a 95^{th} percentile male. For example, the first range, the second range and the third range can be consecutive with respect to one another within the range from the 5^{th} percentile female to the 95^{th} percentile male.

For example, said first range corresponds to a range between 5^{th} percentile female and a 40^{th} percentile male, wherein said second range corresponds to a range between 40^{th} percentile male and a 60^{th} percentile male, and wherein said third range corresponds to a range between 60^{th} percentile male and a 95^{th} percentile male.

Additionally or alternatively, for example, the engagement element is movable between at least three positions, wherein each said position comprises a different said fuse element group, and wherein in each said position the engagement element engages exclusively with the fuse element group comprised at the respective said position.

For example, the fuse system has a respective said operating fuse load rating at each said position correlated with an occupant weight. For example, at a first said position, the respective said operating fuse load rating corresponds to a 5^{th} percentile female, wherein at a second said position the respective said operating fuse load rating corresponds to a 50^{th} percentile male, and wherein at a third said position the respective said operating fuse load rating corresponds to a 95^{th} percentile male.

Additionally or alternatively, for example, each said corresponding predetermined fixed load is a respective tensile load, and wherein each said fuse element is configured for supporting a respective tensile load up to said corresponding predetermined fixed load.

For example, each fuse element is generally flat, having a waisted section intermediate the first fuse end and the second fuse end. For example, at least one said fuse element group comprises two or more said fuse elements juxtaposed with respect to one another, wherein the respective said first fuse ends are aligned with one another, and wherein the respective said second fuse ends are aligned with respect to one another.

Additionally or alternatively, for example, each said corresponding predetermined fixed load is a respective shear load, and wherein each said fuse element is configured for supporting a respective shear load up to said corresponding predetermined fixed load.

Additionally or alternatively, for example, each said corresponding predetermined fixed load is a respective torsional load, and wherein each said fuse element is configured for supporting a respective torsional load up to said corresponding predetermined fixed load.

According to a second aspect of the presently disclosed subject matter there is provided a seating system comprising the energy attenuation system as defined herein regarding the first aspect of the presently disclosed subject matter, the seating system having the bucket and the frame, wherein the engagement element is secured to one of the bucket and the frame, and the respective said first fuse ends of all the fuse elements are secured to the other one of the bucket and the frame.

For example, the seating system further comprises a checking system configured for checking whether the fuse system has been correctly set for the weight of the occupant.

For example, the checking system comprises a weight sensor and a positional sensor, wherein the weight sensor is coupled to the bucket and configured for determining the weight of the occupant when seated on the seat, and wherein the positional sensor is configured for determining the actual position of the engagement element with respect to the position of the engagement element.

For example, the seating system further comprises a control module operatively coupled to the positional sensor and the weight sensor, and wherein the control module is configured for comparing a weight of the occupant, as determined by the weight sensor with a position of the engagement element, as determined by the positional sensor, and for determining whether the position of the engagement element corresponds to the weight of the occupant.

For example, the control module includes a memory with a truth table providing pairs of values for the weight and position that are consistent with one another.

Additionally or alternatively, for example, the control module is configured for generating a first observable signal when the position of the engagement element corresponds to the weight of the occupant. For example, said first observable signal is in the form of a lit green light.

Additionally or alternatively, for example, the control module is configured for generating a second observable signal when the position of the engagement element does not correspond to the weight of the occupant. For example, said first observable signal is in the form of a lit red light.

According to the aforesaid first aspect of the presently disclosed subject matter, there is also provided a fuse system configured for coupling to an energy attenuation system for a seating system having a bucket and a frame, the energy attenuation system comprising at least one energy attenuation component operatively coupled with a fuse system, wherein:
the fuse system comprises a plurality of fuse elements and an engagement element, wherein;
   each said fuse element is configured for breaking under a corresponding predetermined fixed load;
   each said fuse element comprises a respective first fuse end and a respective second fuse end;
   the engagement element is movable with respect to the fuse elements and selectively engageable with any desired number of said fuse elements via the respective said second fuse ends;
   the engagement element is configured for being secured to one of the bucket and the frame, and the respective said first fuse ends of all the fuse elements are configured for being secured to the other one of the bucket and the frame.

According to a third aspect of the presently disclosed subject matter there is provided a method for operating a seating system, the seating system being as defined herein regarding the second aspect of the presently disclosed subject matter, the method comprising engaging the engagement element with a desired said group of fuse elements, corresponding to a weight of an occupant, and allowing the occupant to be accommodated by the seating system.

A feature of at least one example of the presently disclosed subject matter is that a seating system including an energy attenuation system is provided in which a user is subjected to an acceleration during a high energy impact event, and in which such an acceleration is kept below a threshold value, generally consistent with respect to the weight of the user.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 schematically illustrates a seating system coupled to an energy attenuation system according to a first example of the presently disclosed subject matter.

FIG. 2(a) shows in side view a fuse element according to an example of the presently disclosed subject matter; FIG. 2(b) shows in isometric view the example of FIG. 2(a).

FIG. 3 shows in isometric view a fuse system according to a second example of the presently disclosed subject matter.

FIG. 4 shows in partially hidden isometric view the example of FIG. 3.

FIG. 5 shows in partially hidden front view the example of FIG. 4; FIG. 5(a) shows a detail view of the example of FIG. 5.

FIG. 6(a) shows in isometric view an actuation arrangement for operating the fuse system example of FIG. 3; FIG. 6(b) shows a top view of the actuation arrangement example of FIG. 6(a).

FIG. 7(a) schematically illustrates a deceleration vs time relationship for a high energy impact event; FIG. 7(b) illustrates a velocity vs time relationship obtained with computer simulation CS1, conducted for a first FE-MB model (corresponding to a 5^{th} percentile female), with no fuse elements; FIG. 7(c) illustrates an acceleration vs time relationship obtained with the computer simulation CS1 of FIG. 7(b).

FIG. 8(a) compares lumbar load variation with time obtained in the first computer simulation CS1 with that obtained in the second computer simulation CS2; FIG. 8(b) compares stroke variation with time obtained in the first computer simulation CS1 with that obtained in the second computer simulation CS2.

FIG. 9(a) compares lumbar load variation with time obtained in the third computer simulation CS3 with that obtained in the fourth computer simulation CS4; FIG. 9(b) compares stroke variation with time obtained in the third computer simulation CS3 with that obtained in the fourth computer simulation CS4.

FIG. 10(a) compares lumbar load variation with time obtained in the fifth computer simulation CS5 with that obtained in the sixth computer simulation CS6; FIG. 10(b) compares stroke variation with time obtained in the fifth computer simulation CS5 with that obtained in the sixth computer simulation CS6.

FIG. 11(a) compares lumbar load variation with time obtained in the fifth computer simulation CS5 with that obtained in the seventh computer simulation CS7; FIG. 11(b) compares stroke variation with time obtained in the fifth computer simulation CS5 with that obtained in the seventh computer simulation CS7.

FIG. 12 schematically illustrates a seating system coupled to an energy attenuation system according to an alternative variation of the example of FIG. 1.

FIG. 13 shows in isometric view a fuse system according to a third example of the presently disclosed subject matter.

FIG. 14(a) shows in front view and in cross-sectional side view an example of an integrally joined fuse element of the example of FIG. 13; FIG. 14(b) shows in side view another example of an integrally joined fuse element of the example of FIG. 13; FIG. 14(c) shows in top view an example of another integrally joined fuse element of the example of FIG. 13.

FIG. 15 shows in isometric view a fuse system according to a fourth example of the presently disclosed subject matter.

### DETAILED DESCRIPTION

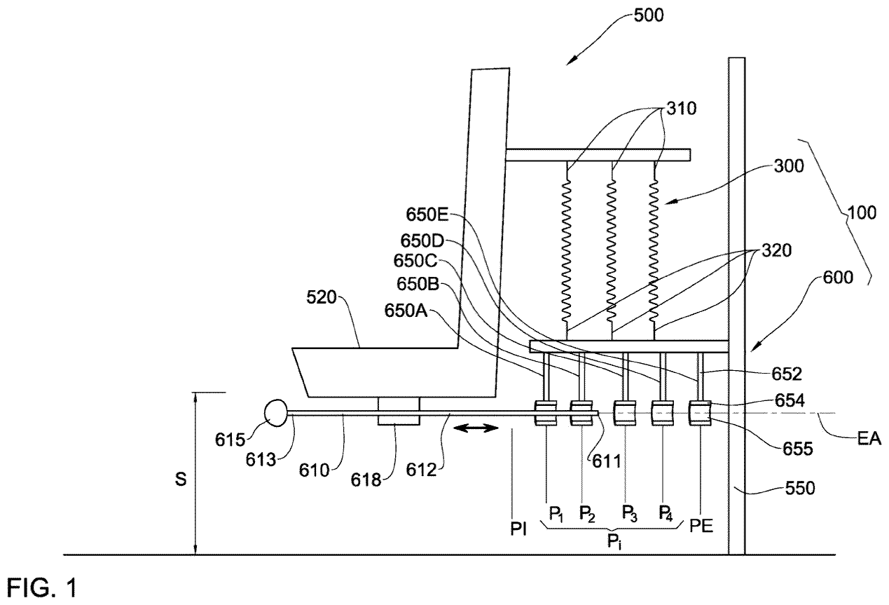

Referring to FIG. 1, an energy attenuation system according to a first example of the presently disclosed subject matter, generally designated 100, comprises at least one energy attenuation component 300 operatively coupled with a fuse system 600, which is also per se novel.

Referring again to FIG. 1, in at least one example, the energy attenuation system 100 is incorporated in a seating system 500 for carrying personnel in an air vehicle, such as a helicopter for example. However, it is to be noted that in at least some other examples, the energy attenuation system 100 can be incorporated in a personnel-carrying seat of any vehicle, for example a fixed wing air vehicle, or a land vehicle, or a sea faring vehicle, or in a personnel-carrying seat of a space vehicle, for example a re-entry capsule or other space vehicle. In any case, such a seating system 500 typically comprises a movable component, in the form of seat (also referred to interchangeably herein as “bucket”) 520, and a nominally stationary component, in the form of stationary base 550. The energy attenuation system 100 essentially connects the seat 520 to the stationary base 550, and operates to provide energy attenuation to the seat, and thus to the occupant, during a high energy impact event, as will become clearer herein.

It is further to be noted that in at least some other examples, the energy attenuation system 100 can instead be incorporated in a cargo or instrumentation support structure, to protect the respective cargo or instrumentation during a high energy impact event. Thus, the term “seating system” includes not only support systems for enabling one or more person to be seated thereon, but also other types of support systems configured for enabling cargo, instrumentation, and so on, to be supported, for example a cargo pallet or the like, and for providing energy attenuation to the movable component (also referred to interchangeably herein as the “seat” or “bucket”) of the support structure with respect to the stationary component (also referred to interchangeably herein as the “stationary base”), and thus for providing energy attenuation to the cargo, instrumentation, and so on, during a high energy impact event, as will become clearer herein.

In any case, the seating system 500 is configured for enabling the seat 520 to be displaced with respect to the stationary base 550 by a maximum stroke S responsive to the occurrence of a high energy impact event.

The energy attenuation components 300 are each configured for attenuating energy during a high energy impact event. Each energy attenuation component 300 comprises a respective first energy attenuation component end 310 configured for being secured to the movable component of the support structure, i.e., the seat 520, and a respective second energy attenuation component end 320 configured for being secured to stationary component of the support structure, i.e., the frame 550.

The energy attenuation components 300 can be of any suitable known type in the art. For example, each energy attenuation component 300 can be in the form of tube and die energy absorbers, in which in operation thereof as the movable component or seat strokes, the tube is drawn through a die which flattens the tube. In other examples, each energy attenuation component 300 can be in the form of aluminum tubes that plastically deform to thereby absorb impact energy. In other examples, each energy attenuation component 300 can be based, for example, on any one of the following concepts as is known in the art: crushable column; rolling torus; inversion tube; cutting or slicing; strap, rod or wire bender; wire-through-platen; deformable links; elongation of tube, strap or cable; tube flaring; housed coiled cable; bar-through-die; hydraulic; pneumatic.

In particular, in at least this example, the energy attenuation components 300 are configured for operating such as to provide a load/deceleration output to the movable component or seat 520, responsive to a load input generated by a high energy impact event. Such a high energy impact event, or the aforesaid load input, can be characterized by a deceleration from zero to a peak threshold deceleration Gₘ within a threshold time tₘ (also referred to herein as the rise time tᵣ), and a corresponding minimum vertical velocity ΔV_{Z}. Such a minimum velocity ΔV_{Z} essentially corresponds to the (vertical) velocity of the air vehicle (i.e., of the seating system) just prior to contact with the ground, for example.

For example, such peak decelerations Gₘ can be in the range of between 46 g and 51 g, and the threshold time tₘ can be in the range 0.036 sec to 0.051 sec, and the minimum velocity of interest ΔV_{Z} is 12.8 m/sec.

In some examples, for example for military helicopter cockpit scenarios, the peak threshold deceleration Gₘ is considered to be (for example, according to “The Evolution of Energy Absorption Systems for Crashworthy Helicopter Seats” (S. P Desjardins, 2003)) about 48 g, and the corresponding threshold time tₘ is 0.027 sec, and the vertical velocity ΔV_{Z} is about 42 ft/sec.

In some other examples, for example, for civil helicopter cabin scenarios, the peak threshold deceleration Gₘ is considered to be (for example, according to “The Evolution of Energy Absorption Systems for Crashworthy Helicopter Seats” (S. P Desjardins, 2003)) about 30 g, and the corresponding threshold time tₘ is 0.044 sec, and the vertical velocity ΔV_{Z} is about 42 ft/sec.

In some other examples, for example, for civil helicopter scenarios, the peak threshold deceleration Gₘ is considered to be (for example, according to “The Evolution of Energy Absorption Systems for Crashworthy Helicopter Seats” (S. P Desjardins, 2003)) about 26 g, and the corresponding threshold time tₘ is 0.031 sec, and the vertical velocity ΔV_{Z} is about 26 ft/sec.

In some other examples, for example as defined in SAE 8049B, for (Type A), transport airplane scenarios, for one example the peak threshold deceleration Gₘ is considered to be about 14 g, and the corresponding threshold time tᵣ is 0.08 sec, and the vertical velocity about 10.67 m/sec.

In another such example, as defined in SAE 8049B, for (Type B), rotorcraft scenarios, the peak threshold deceleration Gₘ is considered to be about 30 g, the corresponding threshold time tᵣ is 0.031 sec, and the vertical velocity about 9.14 m/sec.

In another such example, as defined in SAE 8049B, for (Type C), general aviation aircraft scenarios, for the crew the peak threshold deceleration Gₘ is considered to be about 19 g, the corresponding threshold time tᵣ is 0.05 sec, and the vertical velocity about 9.45 m/see, while for passengers the peak threshold deceleration Gₘ is considered to be about 15 g, the corresponding threshold time tᵣ is 0.06 sec, and the vertical velocity about 9.45 m/sec.

According to an aspect of the presently disclosed subject matter, the aforesaid load/deceleration output that is applied to the movable component or seat 520 is such as to ensure that the maximum load/deceleration output for the duration of the high energy impact event remains below a predetermined threshold lumbar load limit, corresponding to safety limit for the occupant of the seat 520, and wherein the weight of the occupant can vary within a predetermined weight range. According to this aspect of the presently disclosed subject matter, this limitation on the aforesaid load/deceleration output to remain below a predetermined threshold lumbar load limit, varies within the weight range, and the fuse system 600 is provided to enable the limitation on the aforesaid load/deceleration output to be matched (within a tolerance range) to the occupant weight, while utilizing the same energy attenuation components 300 regardless of the occupant weight, as will become clearer herein. By “tolerance range” is meant a range of occupant weights that enables the energy attenuation system 100 to provide lumbar loads that are still within safe limits for the user for the same rating of the fuse system 600.

In general, the higher the weight of the seat occupant, the higher the threshold lumbar load limit can be.

For example, the aforesaid weight range, for example as defined in JSSG-2010-7, can include occupant weights ranging from a 5^{th} percentile female (around 113.4 lbs (51.44 Kg)), through a 50^{th} percentile male (around 170 lbs (77.1 kg)), to a 95^{th} percentile male (around 222.3 lbs (100.8).

For example, the aforesaid weight range from the 5^{th} percentile female to the 95^{th} percentile male can be subdivided into any suitable number of weight ranges, for example into three different ranges including a first range between a 5^{th} percentile female and a 95^{th} percentile male, a second range between a 5^{th} percentile female and a 95^{th} percentile male, and a third range between a 5^{th} percentile female and a 95^{th} percentile male.

For example, the first range corresponds to a range between 5^{th} percentile female and a 40^{th} percentile male, the second range corresponds to a range between 40^{th} percentile male and a 60^{th} percentile male, and the third range corresponds to a range between 60^{th} percentile male and a 95^{th} percentile male.

Alternatively, for example, the first range corresponds to a range between 5^{th} percentile female and a 30^{th} percentile male, the second range corresponds to a range between 30^{th} percentile male and a 70^{th} percentile male, and the third range corresponds to a range between 70^{th} percentile male and a 95^{th} percentile male.

In alternative variations of these examples, however, the aforesaid weight range from the 5^{th} percentile female to the 95^{th} percentile male can be subdivided into two weight ranges, or into more than three weight ranges, for example into 4, 5, 6 or more than 6 weight ranges, each weight range being, for example, between a 5^{th} percentile female and a 95^{th} percentile male. Such threshold lumbar load limits typically correspond to a maximum permitted lumbar load, i.e., the maximum load that is assumed to be safe regarding the spinal column, in particular the lumbar region of the spinal column. Such safety limits depend on the weight of the seat occupant. For example, the publication “Establishing Lumbar Injury Tolerance for Energy Absorbing Seats Criteria and Testing Limitations” (Stanley Desjardins, Conference American Helicopter Society 64^{th} Annual Forum, April 2008) provides three sets of lumbar load limits for a 5^{th} percentile female and for a 95^{th} percentile male, according to each one of different specifications, as set forth in Table I below.

TABLE I
Lumbar Load Limits for a 5^{th} Percentile
Female and for a 95^{th} Percentile Male

| Specification | 5^{th} percentile female lumbar | 95^{th} percentile male lumbar |
|---|---|---|
| Guide | load tolerance (lbf.) | load tolerance (lbf.) |
| JSSG-2010-7 | 1281 | 2534 |
| TR 12-D-12 | 933 | 1757 |
| DRI | 1174 | 2208 |

For example, based on the above table, a universal lumbar load tolerance for 5^{th} percentile female can be set at, say, 1000 lbf, for 95^{th} percentile male at, say, 2000 lbf, and for a 50^{th} percentile male at, say, 1500 lbf.

A first example of the fuse system 600, illustrated in FIG. 1, comprises a plurality of fuse elements 650 and an engagement element 610.

Each said fuse element 650 comprises a respective first fuse end 652 and a respective second fuse end 654.

The engagement element 610 is movable with respect to the fuse elements 650, and the engagement element 610 is selectively engageable serially with any desired number of the fuse elements 650 via the respective second fuse ends 654 of the fuse elements 650.

In at least this example, the respective first fuse ends 652 of all the fuse elements 650 are configured for being secured to the stationary base 550 via respective lumen 656, while the engagement element is configured for being secured to the seat 520. Indeed, in operation of the seating system 500 with the energy attenuation system 100, the respective first fuse ends 652 of all the fuse elements 650 are secured to the stationary base 550, while the engagement element is secured to the seat 520.

It is to be noted, however, that in alternative variations of this example, the respective first fuse ends 652 of all the fuse elements 650 can be configured for being secured to the seat 520, while the engagement element 610 can be configured for being secured to the stationary base 550.

Thus, each of the fuse elements 650 is connected in a load-bearing manner to both the seat 520 and the stationary base 550 only when the engagement element 610 is engaged with the particular fuse element 650 via the respective second fuse end 654 of the particular fuse elements 650.

While in the example illustrated in FIG. 1 the energy attenuation system 100 has five fuse elements 650, it is to be noted that in alternative variations of this example, the energy attenuation system 100 can have any integer number of fuse elements—for example one, two, three, four, six, seven, eight, nine, ten or more than ten fuse elements.

Each fuse element 650 is configured for breaking under a corresponding predetermined load, referred to herein as the respective fuse load (also interchangeably referred to herein as fixed load) FL. In the example of FIG. 1, the individual fuse elements are also annotated with unique reference numerals 650A, 650B, 650C, 650D, 650E, having respective fuse loads FL_{A}, FL_{B}, FL_{C}, FL_{D}, FL_{E}.

The fuse system 600 thus has an operating fuse load rating FLR that corresponds to the summation of the fuse loads FL of the specific fuse elements 650 that are engaged to the seat 520 and the stationary base 550 via the engagement element 610. Each such fuse load can correspond to a different occupant weight range for example between the 5^{th} percentile female and the 95^{th} percentile male.

In the example of FIG. 1, the engagement element 610 comprises a rod member 612 having a free first longitudinal end 611, and a second longitudinal end 613 that carries a graspable knob 615. The engagement element 610, and in particular the rod member 612, is movably mounted to the seat 520 via a bracket 618 that is fixedly mounted to the seat 520.

The second fuse ends 654 of the fuse elements 650 each comprise a respective lumen 655, which are serially and co-axially aligned with one another along an engagement axis EA. While in this example the engagement axis EA is linear, in alternative variations of this example the engagement axis EA can be non-linear, for example curvuate.

The lumens 655 have cross-section having a size and shape complementary to the cross-section of the rod member 612, such that when the rod member 612 passes through each lumen 655, there is load bearing contact between the respective lumen 655 and the rod member 612, and thus between the respective lumen 655 end the engagement element 610.

In the example of FIG. 1, the engagement element 610 is movable along the engagement axis EA between a retracted position PI and an extended position PE via a plurality of positions Pᵢ serially disposed in-between the retracted position PI and the extended position PE.

At the retracted position PI the engagement member is not engaged with any of the fuse elements 650, and thus none of the fuse elements 650 are connected to both the seat 520 and the stationary base 550. In such a case, responsive to a high energy impact event the energy attenuation components 300 alone operate to attenuate the respective impact energy. Thus, at the retracted position PI, the respective fuse load rating FLR is zero.

At the extended position PE, the engagement member is engaged with all of the fuse elements 650, and thus all of the fuse elements 650 are connected to both the seat 520 and the stationary base 550. In such a case, responsive to a high energy impact event the all the fuse elements 650 together absorb part of the respective impact energy during the high energy impact event until the loading on the fuse elements exceeds the combined fuse load of all the fuse elements 650. Thereafter, the energy attenuation components 300 alone operate to attenuate the remaining respective impact energy. Thus, at the extended position PE, the respective fuse load rating FLR is the summation of the fuse loads FL_{A}, FL_{B}, FL_{C}, FL_{D}, FL_{E} of all the fuse elements 650.

At each successive intermediate position Pᵢ, the engagement member is engaged with a group of fuse elements 650 corresponding to the fuse elements 650 that are located between the retracted position PI and the particular intermediate position Pᵢ. Thus, all of the fuse elements 650 in this group are connected to both the seat 520 and the stationary base 550, while the remainder of the fuse elements beyond the respective position Pᵢ and up to the second position are not connected to both the seat 520 and the stationary base 550. In such a case, responsive to a high energy impact event the all the fuse elements 650 in this group together absorb part of the respective impact energy during the high energy impact event until the loading on the fuse elements exceeds the combined fuse load of all the fuse elements 650 in this group. Thereafter the fuse elements 650 in this group break or otherwise fail mechanically, and then the energy attenuation components 300 alone operate to attenuate the remaining respective impact energy. Thus, at each respective intermediate position Pᵢ, the respective fuse load rating FLR is the summation of the fuse loads FL of all the fuse elements 650 of the respective group.

For example, in the example illustrated in FIG. 1, the engagement member 610 is at intermediate position P₂, and is thus engaged in a load-bearing manner with the group of fuse elements consisting of the first fuse element 650A and the second fuse element 650B. The first fuse element 650A and the second fuse element 650B are thus connected in a load bearing manner with both the seat 550 and the stationary base 520. On the other hand, in this example, the remaining fuse elements 650C, 650D, 650E are not engaged with the engagement member 610, and thus are not in load-bearing connected relationship with both the seat 550 and the stationary base 520. In this example, responsive to a high energy impact event the all the fuse elements 650 in this group, i.e., first fuse element 650A and the second fuse element 650B, together absorb part of the respective impact energy during the high energy impact event until the loading on the fuse elements exceeds the combined fuse load of all the fuse elements 650 in this group. Thereafter the fuse elements 650 in this group, i.e., first fuse element 650A and the second fuse element 650B, break or otherwise fail mechanically, and then the energy attenuation components 300 alone operate to attenuate the remaining respective impact energy. Thus, in this example, at the second intermediate position P₂, the respective fuse load rating FLR is the summation of the fuse loads FL_{A} and FL_{B} of all the first fuse element 650A and the second fuse element 650B which make up this group.

The fuse loads FL of each of the fuse elements 650 can be the same or different from one another.

Thus, a fuse load rating FLR is associated with each position, from the retracted position PI, through each intermediate position Pᵢ, and to the extended position PE.

The fuse load rating at each position is correlated with an occupant weight. For example, the retracted position PI or the first intermediate position Pᵢ can be associated with a 5^{th} percentile female, while the extended position PE can be associated with a 95^{th} percentile male, and each intermediate position can be associated with an occupant weight pro-rata intermediate between the 5^{th} percentile female and the 95^{th} percentile male.

Alternatively, for example, each intermediate position can be associated with an occupant weight range pro-rata intermediate between the 5^{th} percentile female and the 95^{th} percentile male—for example:
1^{st} range ˜5^{th} percentile female to 10^{th} percentile male;
2^{nd} range ˜10^{th} percentile male to 30^{th} percentile male;
3^{rd} range ˜30^{th} percentile male to 50^{th} percentile male;
4^{th} range ˜50^{th} percentile male to 70^{th} percentile male;
5^{th} range ˜70^{th} percentile male to 80^{th} percentile male;
6^{th} range ˜80^{th} percentile male to 95^{th} percentile male.

Thus, when using the seating system to accommodate a user having a particular weight, the fuse system 600 is first manipulated to displace the engagement element 610 along engagement axis EA to engage the appropriate number of fuse elements 650 corresponding to the weight of the user—the heavier the user, the more fuse elements 650 that are engaged with the engagement element 610. Thus, the engagement element 610 is moved to a specific position of the positions from PI to PE, corresponding to the weight of the user. Each position PI to PE can correspond to a different weight range for the user.

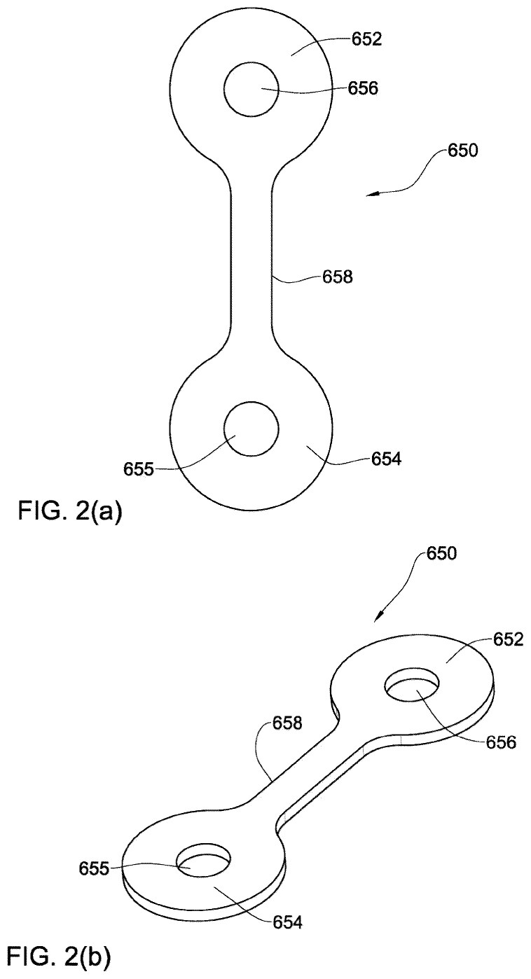

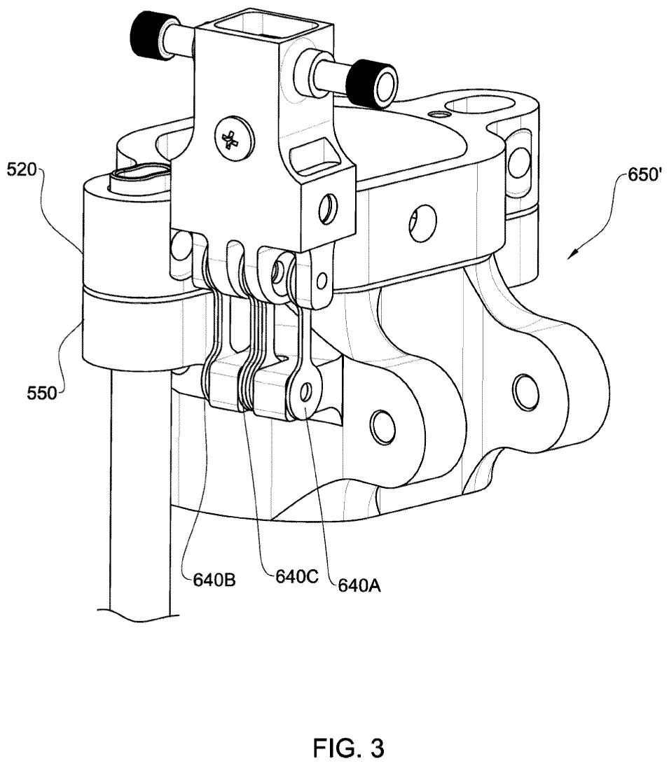

Referring to FIG. 2(a) and FIG. 2(b), an example of a fuse element 650 is illustrated, wherein the fuse element is generally flat, and comprises a waisted section 658 intermediate the first fuse end 652 and the second fuse end 654. When subjected to a tensile load between the first fuse end 652 and the second fuse end 654, so long as the tensile load is less than the respective fuse load FL of the fuse element 650, the fuse element 650 resists the tensile load. If the tensile load exceeds the respective fuse load FL of the fuse element 650, the fuse element 650 breaks or otherwise fails, typically at the waisted section 658, and can no longer resist any loads between the first fuse end 652 and the second fuse end 654. For example, at least one fuse element 650 can be designed to fail at a tensile loading corresponding to the threshold lumbar load limit of, for example, a 5^{th} percentile female. Alternatively, for example, at least one fuse element 650 can be designed to fail at a tensile loading corresponding to a portion of the threshold lumbar load limit of, for example, a 95^{th} percentile male.

For example, in the example of FIG. 1 the engagement element 610 progressively engages more and more fuse elements 650 as the engagement element 610 is displaced from the retracted position PI to the extended position PE. In such a case, the first fuse element 650A can be designed having a respective fuse load FL_{A} corresponding to the threshold lumbar load limit of, for example, a 5^{th} percentile female. On the other hand, the summation of the fuse loads FL_{A}, FL_{B}, FL_{C}, FL_{D}, FL_{E} of all the fuse elements 650 can be designed having a respective combined fuse load FL_{T} corresponding to the threshold lumbar load limit of, for example, a 95^{th} percentile male. The fuse loads FL_{B}, FL_{C}, FL_{D}, FL_{E} can each be chosen as a percentage of the difference (FL_{T}−FL_{A}), such that the summation of the fuse loads FL_{B}, FL_{C}, FL_{D}, FL_{E} correspond to the difference (FL_{T}−FL_{A}). For example, each one of the fuse loads FL_{B}, FL_{C}, FL_{D}, FL_{E} can be equal to one another, and correspond to 25% of the difference (FL_{T}−FL_{A}). Alternatively, for example, the fuse loads FL_{B}, FL_{C}, FL_{D}, FL_{E} can correspond to 10%, 30%, 40% and 20%, respectively of the difference (FL_{T}−FL_{A}).

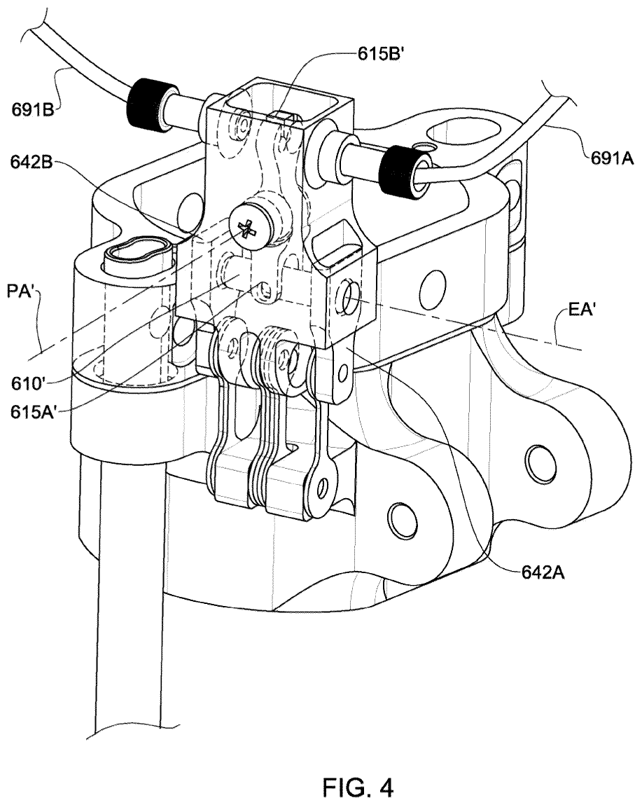

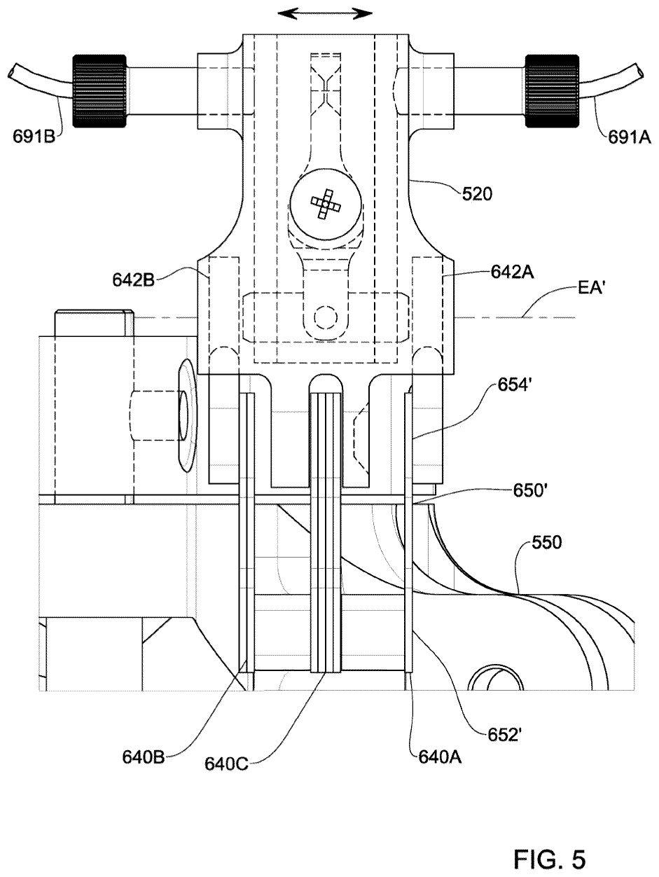

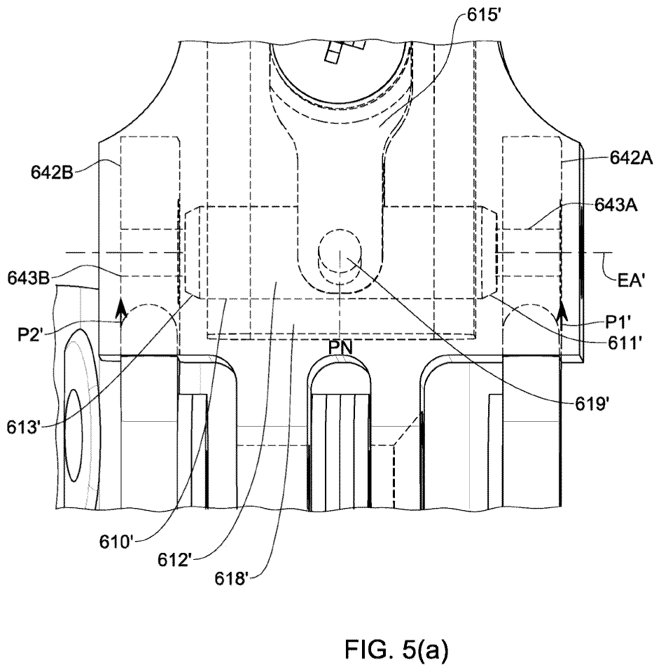

A second example of the fuse system, designated with reference numeral 600′, is illustrated in FIGS. 3 to 6, and comprises a plurality of fuse elements 650′ and an engagement element 610′ similar to the fuse elements 650 and engagement element 610 of the first example, mutatis mutandis, with some differences, as will become clearer herein.

Each said fuse element 650′ comprises a respective first fuse end 652′ and a respective second fuse end 654′. Each fuse element 650′ can be in the form of the fuse element 650 disclosed herein with reference to FIG. 2, mutatis mutandis.

In this example, three groups of fuse elements 650′ are provided:
a first group 640A, comprising for example a single fuse element 650′;
a second group 640B, comprising for example two fuse elements 650′;
a third group 640C, comprising for example four fuse elements 650′.

In at least this example, the respective first fuse ends 652′ of all the fuse elements 650′ of group 640C are configured for being secured to the stationary base 550, while the respective second fuse ends 654′ of all the fuse elements 650′ of group 640C are configured for being secured to the seat 520. Indeed, in operation of the seating system 500 with the energy attenuation system 100, the respective first fuse ends 652′ of all the fuse elements 650′ of group 640C are secured to the stationary base 550, while the respective second fuse ends 654′ of all the fuse elements 650′ of group 640C secured to the seat 520.

In at least this example, the respective first fuse ends 652′ of all the fuse elements 650′ of each of the groups 640A, 640B are configured for being secured to the stationary base 550, while the engagement element is configured for being secured to the seat 520. Indeed, in operation of the seating system 500 with the energy attenuation system 100, the respective first fuse ends 652′ of all the fuse elements 650′ of each of the groups 640A, 640B are secured to the stationary base 550, while the engagement element 610′ is secured to the seat 520.

The respective second fuse ends 654′ of all the fuse elements 650′ of the first group 640A are affixed to a first bracket 642A. The respective second fuse ends 654′ of all the fuse elements 650′ of the second group 640B are affixed to a first bracket 642A.

The first bracket 642A has a first engagement aperture 643A, and the second bracket 642B has a second engagement aperture 643B.

The engagement element 610′ is reciprocably movable with respect to the fuse elements 650′, along engagement axis EA′, and the engagement element 610′ is selectively engageable with either the first bracket 642A via a first engagement aperture 643A by moving in one direction along the engagement axis EA′ to a first position P1′, or with the second bracket 642B via the second engagement aperture 643B by moving in the other direction along the engagement axis EA′ to a second position P2′.

The engagement element 610′ also has a neutral position PN along the engagement axis EA′, intermediate the first position P1′ and the second position P2′, in which the engagement element 610′ is not in load bearing engagement with either the first bracket 642A or the second bracket 642B.

Thus:
the first group 640A of fuse elements 650′ is connected in a load-bearing manner to both the seat 520 and the stationary base 550 only when the engagement element 610′ is engaged with the first bracket 642A;
the second group 640B of fuse elements 650′ is connected in a load-bearing manner to both the seat 520 and the stationary base 550 only when the engagement element 610′ is engaged with the second bracket 642B;
the third group 640C of fuse elements 650′ is always connected in a load bearing manner to both the seat 520 and the stationary base 550 regardless of the position of the engagement element 610′.

The fuse system 600′ thus has three different operating fuse load ratings FLR:
a first fuse rating FLR1 when the engagement element 610′ is in the first position P1′, the first fuse rating FLR1 corresponding to the summation of the fuse loads FL of the specific fuse elements 650′ that are included in the first fuse group 640A and the third group 640C, which correspond to the actual fuse elements that are engaged to the seat 520 and the stationary base 550 at the first position P1′;
a second fuse rating FLR2 when the engagement element 610′ is in the second position P2′, the second fuse rating FLR2 corresponding to the summation of the fuse loads FL of the specific fuse elements 650′ that are included in the second fuse group 640B and the third group 640C, which correspond to the actual fuse elements that are engaged to the seat 520 and the stationary base 550 at the second position P2′;
a third fuse rating FLR3 when the engagement element 610′ is in neutral position PN, the third fuse rating FLR3 corresponding to the summation of the fuse loads FL of the specific fuse elements 650′ that are included in the third group 640C, which correspond to the actual fuse elements that are engaged to the seat 520 and the stationary base 550 at the neutral position PN.

In the example of FIGS. 3 to 6, the engagement element 610′ comprises a rod member 612′ having a free first longitudinal end 611′, and a free second longitudinal end 613′. The engagement element 610′, and in particular the rod member 612′, is movably mounted to the seat 520 via a bracket 618′ that is fixedly mounted to the seat 520.

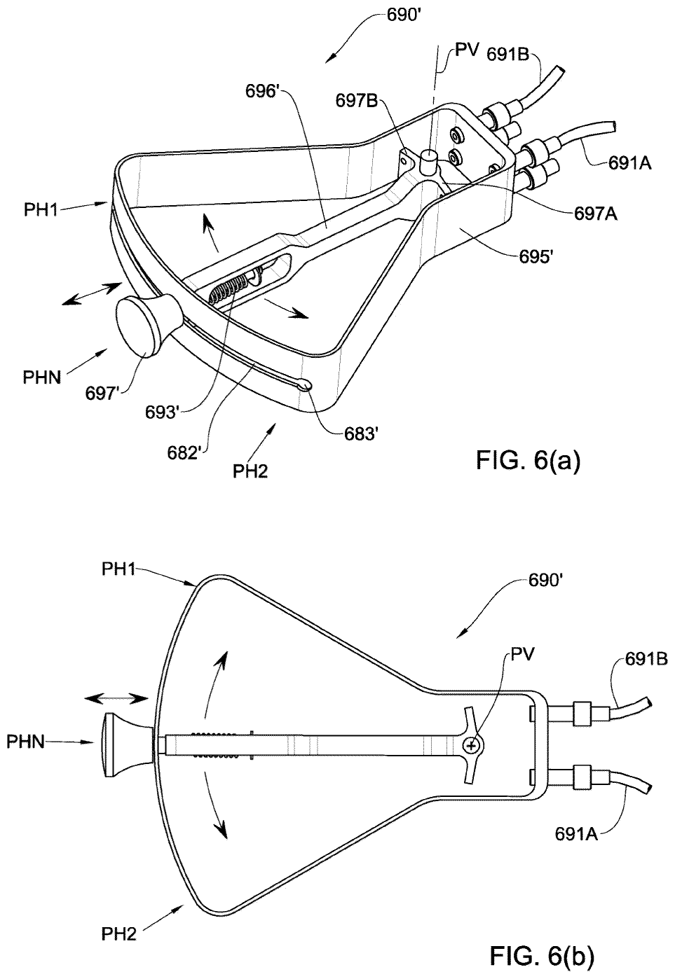

A link 615′ is pivotably mounted to the bracket 618′ about pivot axis PA′. A first end 615A′ of the link is coupled to a central portion of the rod member 612′ via a pin arrangement 619′. A second end 615B′ of the rod member 612′ is operatively coupled to an actuation arrangement 690′ (FIG. 6) for example via two sets of wires 691A, 691B.

The actuation arrangement 690′ comprises an actuation handle 696′ pivotably mounted in a housing 695′ about pivot axis PV. The actuation handle 696′ is reversibly pivotably movable in one direction with respect to the housing 695′ from a central neutral position PHN to a first handle position PH1. The actuation handle 696′ is also reversibly pivotably movable in another direction with respect to the housing 695′ from the central neutral position PHN to a second handle position PH2.

A graspable knob 697′ having an enlarged portion (not shown) is coupled to the actuation handle 696′ via a biasing member 693′. The housing has a front wall 680′ including a slit 682′, and the slit 682′ has an enlarged opening 683′ at each one of the first handle position PH1, the neutral position PHN, and the second handle position PH2. The slit 682′ is too narrow to allow the enlarged portion to pass therethrough, but each of the enlarged opening 683′ is large enough to allow the enlarged portion to pass therethrough.

Thus, by pulling the knob 697′ away from the housing against the force of the biasing member 693′, the enlarged position is pulled out of the respective enlarged opening 683′, allowing the handle 696′ to be pivoted between any of the three positions PH1, PHN, PH2. Once the handle 696′ is in the desired position PH1, PHN or PH2, the knob 697′ can be released, and the biasing member 693′ essentially locks the enlarged portion in the respective enlarged opening 683′.

The actuation handle 696′ comprises lateral brackets 697A, 697B projecting in opposite directions from the pivot axis PV.

The first set of wires 691A has a respective first end connected to one side of the second end 615B′, and the second set of wires 691A has a respective first end connected to another side of the second end 615B′.

The first set of wires 691A has a respective second end connected to lateral bracket 697A, and the second set of wires 691A has a respective second end connected to the other lateral bracket 697B.

Thus, when the actuation handle 696′ is in the neutral position PHN, the first set of wires 691A and the second set of wires 691B ensure that the second end 615B′ of the rod member 612′ is in a neutral position, and thus that the engagement member 610′ is in the neutral position PN.

When the actuation handle 696′ is in the first handle position PH1, the first set of wires 691A are pulled, thereby pulling the second end 615B′ of the rod member 612′ is one direction, and via pivoting about the pivot axis PA, causes the rod member 612′ to be moved to the first position P1′, thereby engaging the first group 640A via the first bracket 642A.

Conversely, when the actuation handle 696′ is in the second handle position PH2, the second set of wires 691B are pulled, thereby pulling the second end 615B′ of the rod member 612′ is the opposite direction, and via pivoting about the pivot axis PA, causes the rod member 612′ to be moved to the second position P2′, thereby engaging the second group 640B via the second bracket 642B.

The fuse load rating at each position P1′, PN, P2′ is correlated with an occupant weight. For example, the neutral position PN (and thus the neutral handle position PHN) can be associated with a 5^{th} percentile female, while the second position P2′ (and thus the second handle position PH2) can be associated with a 95^{th} percentile male, while the first position P1′ (and thus the first handle position PH1) can be associated with a 50^{th} percentile male.

Thus, when using the seating system to accommodate a user having a particular weight, the fuse system 600′ is manipulated by moving the actuation handle 696′ to the appropriate position PH1, PHN or PH2, to correspondingly displace the engagement element 610′ along engagement axis EA′ to engage the appropriate number of fuse elements 650′ corresponding to the weight of the user via the appropriate combination of the third group 640C with one or none of the first group 640A or the second group 640B. Each position PH1, PHN, PH2 can correspond to a respective weight range for the user.

For example, at position PH1, the respective operating fuse load rating corresponds to a first range between a 5^{th} percentile female and a 95^{th} percentile male, at neutral position PHN the respective said operating fuse load rating corresponds to a second range between a 5^{th} percentile female and a 95^{th} percentile male, and at the second position PH2 the respective operating fuse load rating corresponds to a third range between a 5^{th} percentile female and a 95^{th} percentile male.

For example, the first range corresponds to a range between 5^{th} percentile female and a 40^{th} percentile male, the second range corresponds to a range between 40^{th} percentile male and a 60^{th} percentile male, and the third range corresponds to a range between 60^{th} percentile male and a 95^{th} percentile male.

Alternatively, for example, the first range corresponds to a range between 5^{th} percentile female and a 30^{th} percentile male, the second range corresponds to a range between 30^{th} percentile male and a 70^{th} percentile male, and the third range corresponds to a range between 70^{th} percentile male and a 95^{th} percentile male.

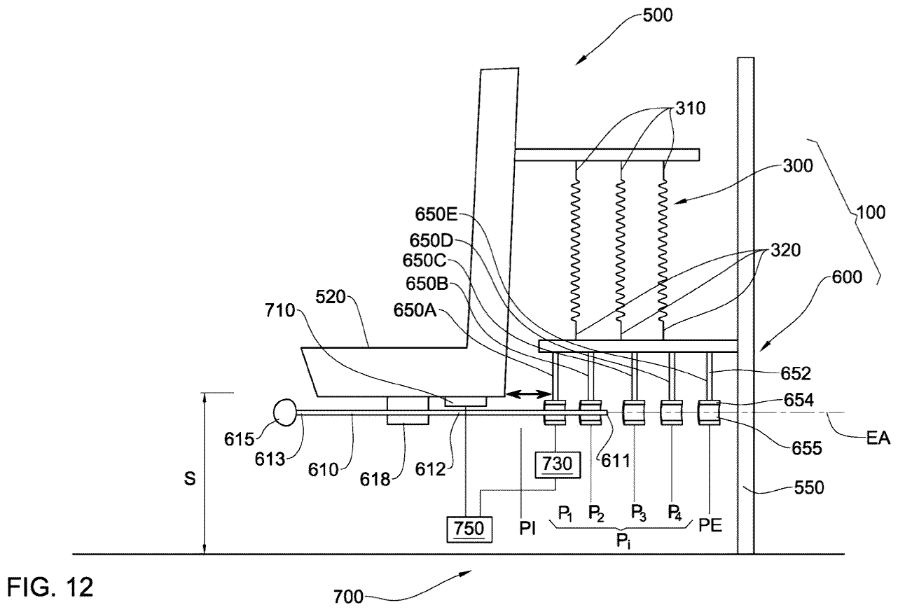

In an alternative variation of the example of FIG. 1, and referring to FIG. 12, the seating system 500 further comprises a checking system 700 to check whether the fuse system 600 has been correctly set for the weight of the user. The checking system 700 comprises a weight sensor 710, coupled to the seat 550, and configured for determining the weight of the occupant when seated on the seat 550. The checking system also comprises a positional sensor 730, configured for determining the actual position of the engagement element 610 with respect positions PI to PE. The positional sensor 730 and the weight sensor 710 are coupled to a control module 750. The control module 750 is configured for comparing the weight of the occupant, as determined by the weight sensor 710, with the position of the engagement element 610, as determined by the positional sensor 730, and to determine whether the position of the engagement element corresponds to the weight of the occupant. For example, the control module 750 can include a memory with a truth table providing pairs of values for the weight and position that are consistent with one another.

In the event that the position of the engagement element corresponds to the weight of the occupant, the control module 750 can generate an observable signal, for example switching on a green light and/or generating a particular sound.

In the event that the position of the engagement element does not correspond to the weight of the occupant, the control module 750 can generate a different observable signal, for example switching on a red light and/or generating an alarm sound, to warn the user of the inconsistency, so that remedial action can be taken.

For example, the control module 750 can be electronic or in the form of a microprocessor.

For example, the positional sensor 730 can include, for example, any suitable potentiometer that is configured for providing a signal that is proportional to the position of the engagement element 610.

For example, the weight sensor 710 can include strain gauges or any other suitable devices that provide an output signal proportional to the weight of the occupant.

A series of computer simulations were conducted to evaluate some examples of the energy attenuation system of the presently disclosed subject matter. For this purpose, an energy attenuation system was modelled in the computer simulations, including at least one energy attenuation component, for example corresponding to the energy attenuation component 300. For some of the computer simulations the energy attenuation component was operatively coupled with a fuse element, corresponding to a fuse element 650.

The seating system 500 was modelled in the computer simulations using Altair Radioss software (provided by Altair Engineering Inc.).

In real dynamic tests for evaluating aircraft seat crashworthiness, an Anthropomorphic Test Device (ATD), also known as a crash test dummy, is conventionally used. Such an ATD is regarded as a high-precision test platform for providing an indication of the impact of crashes on the human body and thus evaluate possible injuries that can be expected on a human body under similar crash conditions.

In the computer simulations two virtual equivalents of the ATD were provided, each in the form of a finite element multibody (FE-MB) computer model. Each FE-MB model, which included respective computer simulated safety belts, was created using Simcenter Madymo Software (provided by Siemens Digital Industries).

The FE-MB computer models were first validated using data from real physical dynamic tests performed on the ATD.

The computer simulations of each simulated high-energy impact event were modelled using Altair Radioss software and Simcenter Madymo software.

In the computer simulations, the simulated energy attenuation system was coupled to the computer model of the seating system, similar to the coupling of the energy attenuation system 100 with seating system 500 as disclosed herein, mutatis mutandis.

A first FE-MB model was used for the simulations, representing a human body having a weight corresponding to a 5^{th} percentile female. In respective computer simulations relating to the 5^{th} percentile female, the first FE-MB model was coupled to the computer model of the seating system in a manner corresponding to the manner in which a human occupant is accommodated in the seating system 500, mutatis mutandis.

A second FE-MB model was also used for the simulations representing a human body having a weight corresponding to a 95^{th} percentile male. In respective computer simulations relating to the 95^{th} percentile male, the second FE-MB model was coupled to the computer model of the seating system in a manner corresponding to the manner in which a human occupant is accommodated in the seating system 500, mutatis mutandis.

The computer simulations were designed to evaluate simulated lumbar loads generated on the lumbar part of the respective FE-MB model, corresponding to the lumbar area of the corresponding human body, responsive to the respective FE-MB model being subjected to a computer simulated high energy impact event.

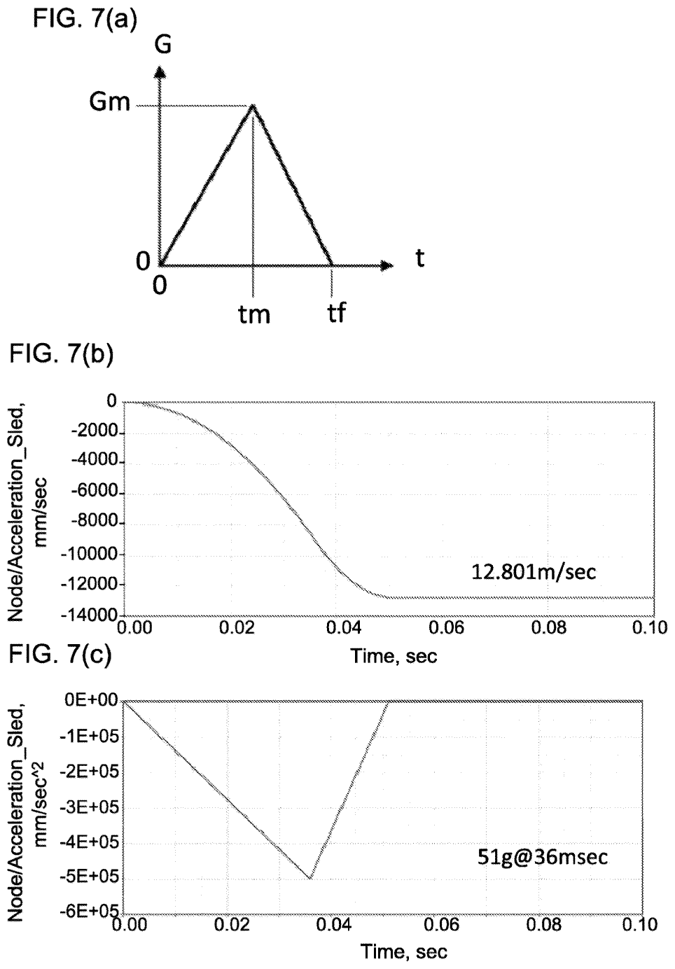

Referring to FIG. 7(a) and FIG. 7(c), the high energy impact event was modeled in the computer simulations as an impact force pulse applied to the seat of the modelled seating system, corresponding to a change in deceleration from zero to a peak decelerations Gₘ of about 50 g in a threshold time tₘ of about 36 milliseconds, and then followed by another change in deceleration from 50 g back to zero in another time period tᵣ of 20 milliseconds approximately. Referring to FIG. 7(b), the corresponding minimum velocity reached by the seat prior to contact with the ground was modelled at 12.8 m/s.

For the computer simulations, a maximum lumbar load tolerance for 5^{th} percentile female was set at 1000 lbf, for 95^{th} percentile male at 2000 lbf, based on Table I above.

A first computer simulation CS1 was conducted for the first FE-MB model (corresponding to a 5^{th} percentile female), with no fuse elements, and with the energy attenuation system modelled to provide the maximum lumbar load on the first FE-MB model not exceeding the 1000 lbf limit.

A second computer simulation CS2 was conducted for the second FE-MB model (corresponding to a 95% male percentile), with no fuse elements, and with the energy attenuation system set exactly as in the first computer simulation CS1.

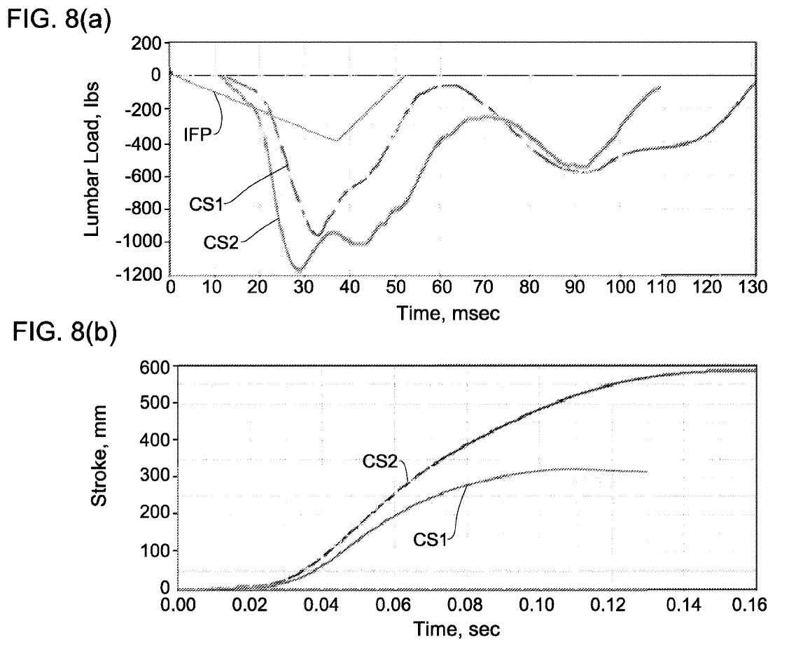

FIGS. 8(a) and 8(b) compare the results obtained in the first computer simulation and in the second computer simulation.

Referring to FIG. 8(a), the variation in simulated lumbar load with time for the first computer simulation CS1 is compared with that of the second computer simulation CS2, and this figure also schematically illustrates the impact force pulse IFP, which is to scale only along the time axis.

As can be readily understood from FIG. 8(a), the lumbar loads determined for the first computer simulation CS1 never exceeds the maximum lumbar load tolerance for 5^{th} percentile female of 1000 lbf, and a maximum peak of just under 1000 lbf occurs at a first peak at around 36 milliseconds. On the other hand, the maximum peak in lumbar loads determined for the second computer simulation CS2 is about 1200 lbf (at about 30 milliseconds), which is well under the maximum lumbar load tolerance for 95^{th} percentile male of 2000 lbf.

As can be seen from FIG. 8(b), the corresponding seat stroke S for the first computer simulation CS1 was 332 mm, while for the second computer simulation, the corresponding seat stroke S was 587 mm. In at least some real-life implementations corresponding to the first computer simulation CS1 and the second computer simulation CS2, a seat stroke length of 587 mm could be considered unrealistic.

A third computer simulation CS3 was conducted for the first FE-MB model (corresponding to a 5^{th} percentile female), with the energy attenuation system set exactly as in the first computer simulation, and also including a first fuse element. The first fuse element was modelled to provide the maximum lumbar load on the first FE-MB model not exceeding the 1000 lbf limit. To arrive at the fuse properties (for example, the maximum load that can be applied to the fuse element before it loses mechanical integrity (in the computer model)) that are consistent with providing the aforesaid maximum lumbar load on the first FE-MB model, a number of computer simulations were conducted, each time increasing the virtual mechanical properties of the fuse element, and determining the lumbar load in each case, until the predicted lumbar load reaches, but does not exceed, the aforesaid 1000 lbf limit.

A fourth computer simulation CS4 was conducted for the second FE-MB model (corresponding to a 95^{th} male percentile), with the energy attenuation system and the fuse element set exactly as in the third computer simulation.

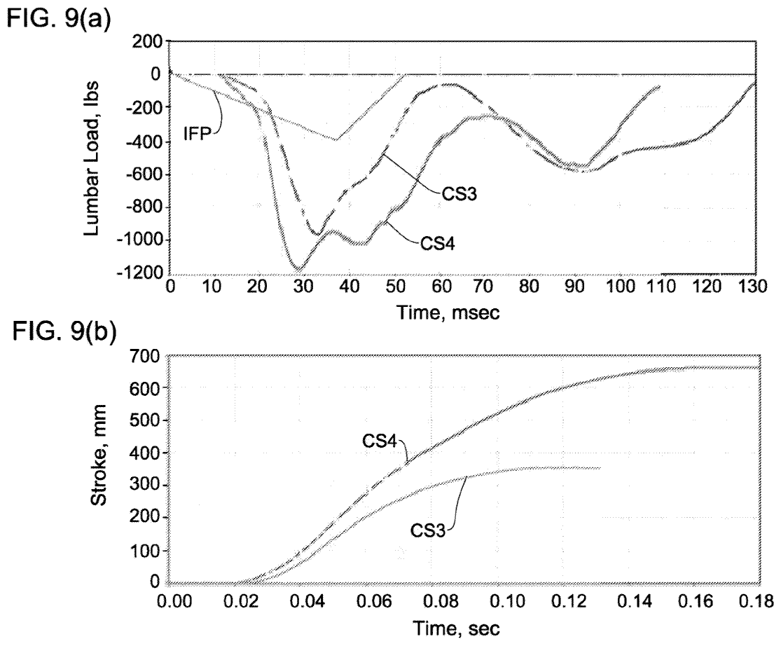

FIGS. 9(a) and 9(b) compare the results obtained in the third computer simulation and in the fourth computer simulation.

Referring to FIG. 9(a), the variation in lumbar load with time for the third computer simulation CS3 is compared with that of the fourth computer simulation CS4, and this figure also schematically illustrates the impact force pulse IFP, which is to scale only along the time axis.

As can be readily understood from FIG. 9(a), the lumbar loads determined for the third computer simulation CS3 also never exceeds the maximum lumbar load tolerance for 5^{th} percentile female of 1000 lbf, and a maximum peak of just under 1000 lbf occurs at a first peak at around 30 milliseconds. On the other hand, the maximum peak in lumbar loads determined for the fourth computer simulation CS2 is about 1200900 lbf (at about 4028 milliseconds), which is well under the maximum lumbar load tolerance for 95^{th} percentile male of 2000 lbf.

As can be seen from FIG. 9(b), the corresponding seat stroke S for the third computer simulation CS3 was 358 mm (longer than for the first computer simulation CS1), while for the second computer simulation, the corresponding seat stroke S was 660 mm (much longer than for the second computer simulation CS2). In at least some real-life implementations of the third computer simulation CS3 and the fourth computer simulation CS4, a seat stroke length of 660 mm could be considered unrealistic.

A fifth computer simulation CS5 was conducted for the first FE-MB model (corresponding to a 5^{th} percentile female), with an energy attenuation system, and the first fuse element set exactly as in the third and fourth computer simulations. The energy attenuation system was modelled to extend the time period at which the maximum lumbar load (or close thereto) was applied on the first FE-MB model, while not exceeding the 1000 lbf limit. To arrive at the properties for the energy attenuation system (for example, dampening characteristics) that are consistent with providing the aforesaid extension of the time period at which the maximum lumbar load (or close thereto) was applied on the first FE-MB model, a number of computer simulations were conducted, each time changing the virtual properties of the energy attenuation system, and determining the characteristics of the lumbar load variation with time in each case, until the predicted lumbar load variation reaches the desired form.

Without being bound to theory, inventor considered that the level of energy attenuation is a function of the integral of the lumbar load variation with time. Thus, for a given level of attenuation energy that is required for a particular user weight, if the lumbar load can be maintained close to but not exceeding the maximum permissible lumbar load for this weight for as long as possible, the shorter is the time period required for the energy attenuation system to operate, and the shorter the seat stroke.

A sixth computer simulation CS6 was conducted for the second FE-MB model (corresponding to a 95^{th} male percentile), with the energy attenuation system and the first fuse element set exactly as in the fifth computer simulation CS5.

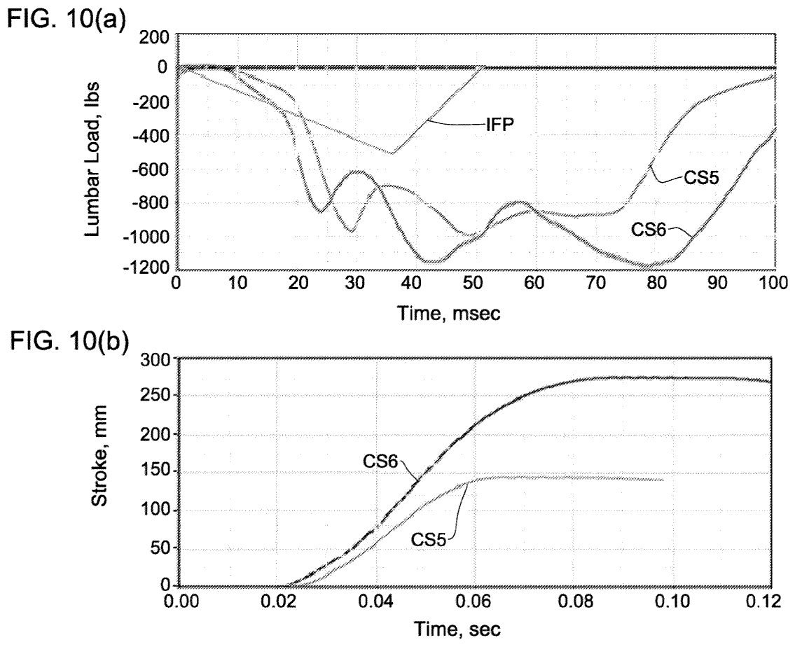

FIGS. 10(a) and 10(b) compare the results obtained in the fifth computer simulation CS5 and in the sixth computer simulation CS6.

Referring to FIG. 10(a), the variation in lumbar load with time for the fifth computer simulation CS5 is compared with that of the sixth computer simulation CS6, and this figure also schematically illustrates the impact force pulse IFP, which is to scale only along the time axis.

As can be readily understood from FIG. 10(a), the lumbar loads determined for the fifth computer simulation CS5 never exceeds the maximum lumbar load tolerance for 5^{th} percentile female of 1000 lbf. Furthermore, while there is a first maximum peak of just under 1000 lbf occurs at around 30 milliseconds, the lumbar load peak again at under 1000 lbf at around 50 milliseconds. It also to be noted that the lumbar loads remain high on average in the order of about 820 lbf between 30 milliseconds and 75 milliseconds. On the other hand, the maximum peak in lumbar loads determined for the sixth computer simulation CS6 is about 1200 lbf (at about 40 and at about 80 milliseconds), which is still well under the maximum lumbar load tolerance for 95^{th} percentile male of 2000 lbf.

As can be seen from FIG. 10(b), the corresponding seat stroke S for the fifth computer simulation CS5 was 142 mm (less than half of that in the first computer simulation CS1 or in the third computer simulation CS3), while for the sixth computer simulation CS6, the corresponding seat stroke S was 275 (less than half of that in the second computer simulation CS2 or in the fourth computer simulation CS4).

A seventh computer simulation CS7 was conducted for the second FE-MB model (corresponding to a 95^{th} percentile male), with a second fuse element, and with an energy attenuation system set exactly as in the fifth and sixth computer simulations. The second fuse element replaced the first fuse element. The second fuse element was modelled to provide the maximum lumbar load on the second FE-MB model while not exceeding the 1000 lbf limit. To arrive at the fuse properties (for example, the maximum load that can be applied to the fuse element before it loses mechanical integrity (in the computer model)) that are consistent with providing the aforesaid maximum lumbar load on the second FE-MB model, a number of computer simulations were conducted, each time increasing the virtual mechanical properties of the fuse element, and determining the lumbar load in each case, until the predicted lumbar load reaches, but does not exceed, the aforesaid 1000 lbf limit.

Thus, the first fuse element and the energy attenuation system was optimized for the first FE-MB model (5^{th} percentile female) in the fifth computer simulation CS5, while in the seventh computer simulation CS7 the second fuse element was optimized for the second FE-MB model (95^{th} percentile male) while keeping the same energy attenuation system as in the fifth computer simulation CS5.

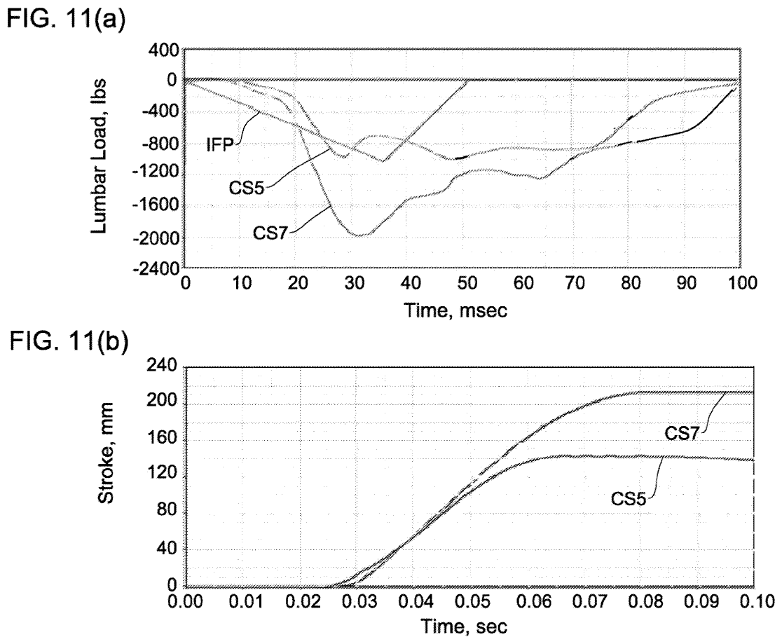

FIGS. 11(a) and 11(b) compare the results obtained in the fifth computer simulation CS5 and in the seventh computer simulation CS7.

Referring to FIG. 11(a), the variation in lumbar load with time for the fifth computer simulation CS5 is compared with that of the seventh computer simulation CS7, and this figure also schematically illustrates the impact force pulse IFP, which is to scale only along the time axis.

As can be readily understood from FIG. 11(a), the lumbar loads determined for the fifth computer simulation CS5 never exceeds the maximum lumbar load tolerance for 5^{th} percentile female of 1000 lbf, and the lumbar loads determined for the seventh computer simulation CS7 never exceeds the maximum lumbar load tolerance for 95^{th} percentile male of 2000 lbf.

Furthermore, and as can be seen from FIG. 11(b), the corresponding seat stroke S for the fifth computer simulation CS5 was 142 mm, while for the seventh computer simulation CS7, the corresponding seat stroke S was 213 mm.

The above simulations demonstrate that the same energy attenuation system can be used successfully for both a 5^{th} percentile female and for a 95^{th} percentile male through realistic seat strokes of between 142 mm and 213 mm, by providing different fuse elements when using the seating system with one or another of the 5^{th} percentile female and the 95th0% percentile male.

While in the above examples, the respective fuse elements are configured for losing mechanical integrity when a threshold level of tensile stress is applied to the fuse elements, in at least some alternative variations of these examples the respective fuse elements can be configured for losing mechanical integrity when a threshold level of torsional stress is applied to the fuse elements. Furthermore, in at least some other alternative variations of these examples the respective fuse elements can be configured for losing mechanical integrity when a threshold level of shearing load is applied to the fuse elements.

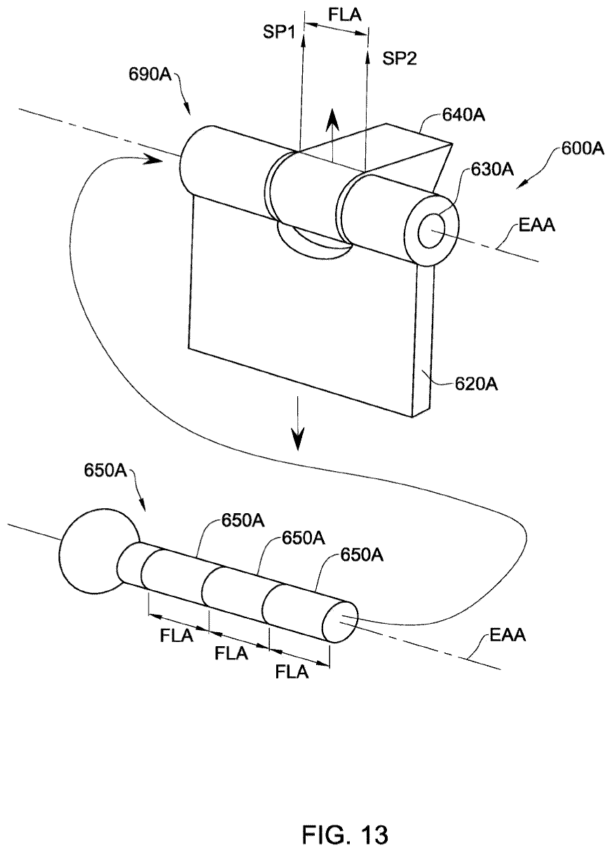

For example, and referring to FIG. 13 a fuse system according to a third example of the presently disclosed subject matter, generally designated 600A, is similar to the first example or second example, mutatis mutandis, but with some differences as will become clearer herein.

In the third example, the fuse system 600A is configured for breaking under shear loads rather than tensile loads.

In this example, the fuse system 600A comprises three fuse elements 650A integrally joined with one another serially along the respective engagement axis EAA. In alternative variations of this example, the fuse system can have two or more than three fuse elements 650A.

The fuse elements 650A all have the same longitudinal dimension FLA.

Each fuse element 650A is configured for shearing under a different specific shear load, when such a shear load is applied to the fuse element. For example, a first said fuse element 650A can be configured for use with a 5^{th} percentile female, the second said fuse element 650A can be configured for use with a 50^{th} percentile female, and the third said fuse element 650A can be configured for use with a 95^{th} percentile male.

In this example, the respective engagement element 690A comprises a first shear element 620A and a second shear element 640A.

The first shear element 620A configured for being secured to the stationary base 550, and the second shear element 640A configured for being secured to the seat 520. The first shear element 620A and the second shear element 640A have respective through-lumens 630A, coaxially aligned with the engagement axis EAA. The lumens 630A have an internal diameter complementary to the external diameter of the fuse elements 650A.

The first shear element 620A and the second shear element 640A define two shear planes SP1, SP2, each orthogonal to the engagement axis EAA, and longitudinally spaced from one another by spacing FLA.

The integrally joined fuse elements 650A are movable as a single body within the lumens 630A, and thus with respect to the engagement element 690A, along the engagement axis EAA at least between each of three longitudinal positions. At each said longitudinal position, a different one of the three fuse elements 650A is longitudinally aligned between the shear planes SP1 and SP2.

In operation of the energy attenuation system with fuse system 600A according to the third example thereof, the integrally joined fuse elements 650A is moved with respect to the engagement element 690A such as to match the weight of the designated occupant of the seating system with the appropriate fuse element 650A, by aligning the appropriate fuse element 650A between the shear planes SP1 and SP2.

When a high energy impact event occurs, shear loads along the shear planes SP1 and SP2 are generated, and at the respective fixed shear load, the respective fuse element 650 shears off, enabling the energy attenuation component to then absorb impact energy.

In alternative variations of this example, the alignment element 690A can define a single shear plane, or more than two shear planes.

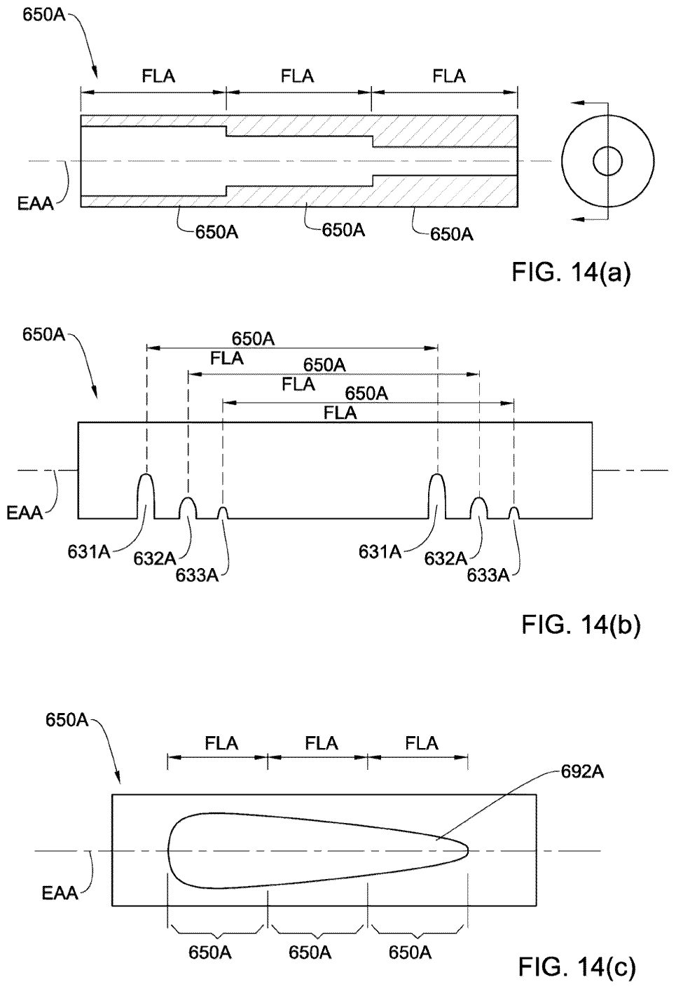

FIGS. 14(a) to 14(c) illustrate a variety of examples of configurations for the engagement element 690A.

In the example of FIG. 14(a), the respective alignment element 690A is generally tubular along the length including the three respective fuse elements 650A, and has a uniform outer diameter. However, the inner diameter corresponding to the first fuse element 650A is larger than for the second fuse element 650A, which is in turn larger than the third fuse element 650A. Thus, the first fuse element 650A has the thinnest tubular wall, the third fuse element 650A has the thickest tubular wall, and the second fuse element has an intermediate tubular thickness. Accordingly, the shear load required to break the alignment element 690A at the third fuse element 650A is greater than that for the second fuse element 650A which is in turn greater than that for the first fuse element 650A.

In the example of FIG. 14(d), the respective alignment element 690A is generally solid cylindrically along the length including the three respective fuse elements 650A, and has a uniform outer diameter. However, the alignment element 690A has three pairs of recesses 631A, 632A, 633A longitudinally spaced along the alignment element 690A. The first pair of recesses 631A (corresponding to the first fuse element 650A) are deeper than the second pair of recesses 632A (corresponding to the second fuse element 650A), which in turn are deeper than the third pair of recesses 633A (corresponding to the third fuse element 650A). The respective recesses of each pair are longitudinally spaced from one another by spacing FLA. The respective engagement element 690A can be moved with respect to the integrally joined fuse elements 650A between any one of three positions. In each such position one or another of the three sets of recesses is aligned with the shear planes SP1 and SP2. In view of the different sized-recesses, the shear load required to break the alignment element 690A at the third fuse element 650A is greater than that for the second fuse element 650A which is in turn greater than that for the first fuse element 650A.

In the example of FIG. 14(c), the respective alignment element 690A has a generally solid cylindrical shape along the length including the three respective fuse elements 650A, and has a uniform outer diameter. The alignment element 690A further comprises a longitudinal slot 692A having a variable width along a longitudinal direction. Thus, the first fuse element 650A has the thinnest transverse wall dimension between the slot 692A and the outer cylindrical surface 693A, the third fuse element 650A has the thickest transverse wall dimension, and the second fuse element has an intermediate transverse wall dimension thickness. Accordingly, the shear load required to break the alignment element 690A at the third fuse element 650A is greater than that for the second fuse element 650A which is in turn greater than that for the first fuse element 650A.

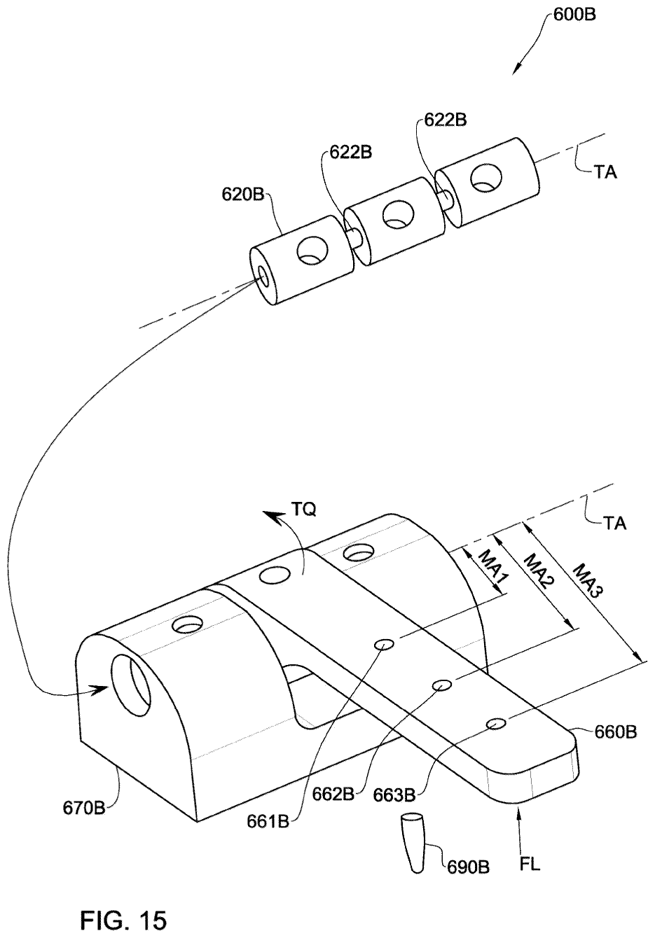

For example, and referring to FIG. 15 a fuse system according to a fourth example of the presently disclosed subject matter, generally designated 600B, is similar to the first example or second example, mutatis mutandis, but with some differences as will become clearer herein.

In the fourth example, the fuse system 600B is configured for breaking under torsional loads rather than tensile loads.

In this example, the fuse system 600B comprises an integral lever 660B coupled to a torsion bar 620B.

The torsion bar 620B has a torsion axis TA, and is configured for torsionally breaking at weakened sections 622B when subjected to a threshold torsional moment or torque TT via pivoting of the integral lever 660B about the torsion axis TA.

Two outer portions of the torsion bar 620B are anchored to a base 670B, which is in turn configured for being secured to the stationary base 550.

The inner portion of the torsion bar 620B is anchored to the integral lever 660B, which is in turn configured for being secured to the seat 520 via the respective engagement element 690B, which in at least this example is in the form of a pin.

In at least this example, the integral lever 660B has three holes 661B, 662B, 663B. serially spaced along the length of the integral lever 660B. However, in alternative variations of this example, the respective integral lever can have two or more than three such holes.

Each hole 661B, 662B, 663B is configured for being engaged with, in turn, with the engagement element 690B, such as to enable engagement of the integral lever 660B with the seat 520 at each one of three different positions (in turn) corresponding to the positions of the holes.

The fuse system 600B is configured such that loads between the seat 520 and the stationary base 550 are applied via the mechanical engagement between the engagement element 690B and the integral lever 660B via one or another of the three holes 661B, 662B, 663B. This in turn generates a torque TQ to the torsion bar 620B about the torque axis TA in view of the respective moment arm between the location of the respective hole in which the engagement element 690B is engaged, and the torque axis TA

In at least this example, the fuse system 600B thus has three different moment arms as follows (however, in alternative variations of this example, the fuse system can have two or more than three fuse elements 650A).

The first (and shortest) moment arm MA1 corresponds to the first hole 661B, the third (and longest) moment arm MA3 corresponds to the third hole 663B, and the second (and intermediate) moment arm MA2 corresponds to the second hole 662B.

Thus, the fuse system 600B comprises, in at least this example, three fuse elements 650B, as follows:
the first fuse element 650B corresponds to the combination of the torsion bar 620B and a portion of the integral lever 660B between the torsion bar 620B and the first hole 661B;
the second fuse element 650B corresponds to the combination of the torsion bar 620B and a portion of the integral lever 660B between the torsion bar 620B and the second hole 662B;
the third fuse element 650B corresponds to the combination of the torsion bar 620B and a portion of the integral lever 660B between the torsion bar 620B and the third hole 663B.

While the threshold torsional torque TT for all three fuse elements 650B is the same, the respective load applied at the respective hole 661B, 662B, 663B is different in view of the different magnitudes of the respective moment arms MA1, MA2, MA3.

Thus, each fuse element 650B is configured for torsionally breaking under a different specific fixed load FL, when such a fixed load is applied to the respective fuse element 650B because of the different-sized moment arms. For example, the third fuse element 650B can be configured for use with a 5^{th} percentile female, since the third moment arm MA3 is the longest and thus the fixed load FL is the smallest to generate the threshold torque TT. Similarly, for example, the second fuse element 650B can be configured for use with a 50^{th} percentile female, and the first fuse element 650B can be configured for use with a 95^{th} percentile male, having the shortest moment arm MA1, and thus subject to a greater fixed load FL for the same threshold torque TT.

In operation of the energy attenuation system with fuse system 600B according to the third example thereof, the integral lever 660B is engaged with the seat 520 by engaging the engagement element 690B to the integral lever 660B via one of the holes 661B 662B, 663B which is chosen such as to match the weight of the designated occupant of the seating system with the appropriate fuse element 650B.

When a high energy impact event occurs, loads are applied to the integral lever 660B at the location of the hole to thereby generate a torque TQ about the torque axis TA. At the respective fixed load corresponding to the weight of the occupant, the torque generated via the corresponding torque arm exceeds the torque threshold TT, and the torsion bar 620B breaks, enabling the energy attenuation component to then absorb impact energy.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

What is claimed:

1-41. (canceled)

42. An energy attenuation system for a seating system having a bucket and a frame, the energy attenuation system comprising:
at least one energy attenuation component operatively coupled with a fuse system,
wherein:
the at least one energy attenuation component is configured for attenuating energy during a high energy impact event, each said energy attenuation component comprising a respective first energy attenuation component end configured for being secured to the bucket, and a respective second energy attenuation component end configured for being secured to the frame;
the fuse system comprises a plurality of fuse elements and an engagement element, wherein;
each said fuse element is configured for breaking under a corresponding predetermined fixed load;
each said fuse element comprises a respective first fuse end and a respective second fuse end;
the engagement element is movable with respect to the fuse elements and thereby selectively engageable in a load bearing manner with any desired fuse element group chosen from at least two said fuse element groups, wherein each said fuse element group comprises one or more said fuse elements, and wherein the engagement element is engageable in a load bearing manner with the one or more fuse elements of the desired fuse element group via the respective said second fuse ends thereof;
the engagement element is configured for being secured to one of the bucket and the frame, and the respective said first fuse ends of all the fuse elements are configured for being secured to the other one of the bucket and the frame.

43. The energy attenuation system according to claim 42, including one of the following:
wherein the at least one energy attenuation component is configured for attenuating energy during a high energy impact event subsequent to the respective fuse element group, that is engaged with the engagement element, breaks;
wherein each said fuse element group, together with said at least one energy attenuation component, are together configured for providing, during a high energy impact event, a respective lumbar load to an occupant of the seating system that is not greater than a predetermined threshold lumbar load limit corresponding to a weight of the occupant;
wherein each said fuse element group, together with said at least one energy attenuation component, are together configured for providing, during a high energy impact event, a respective lumbar load to an occupant of the seating system that is not greater than a predetermined threshold lumbar load limit corresponding to a weight of the occupant, and, wherein said predetermined threshold lumbar load limit corresponds to a safety limit for the occupant;
wherein each said fuse element group, together with said at least one energy attenuation component, are together configured for providing, during a high energy impact event, a respective lumbar load to an occupant of the seating system that is not greater than a predetermined threshold lumbar load limit corresponding to a weight of the occupant, and, wherein said predetermined threshold lumbar load limit increases as a weight of the occupant increases.

44. The energy attenuation system according to claim 42, including one of the following:
wherein each said fuse element group has a respective operating fuse load rating corresponding to a summation of the fixed loads of the specific fuse elements that are included in the respective said fuse group;
wherein the energy attenuation system is configured for use with each one, in turn, of a plurality of said occupants including a minimum-weight said occupant and a maximum-weight said occupant, and including at least a first said fuse element group corresponding to said minimum-weight occupant, and a second said fuse element group corresponding to the maximum-weight occupant;
wherein the energy attenuation system is configured for extending a time period at which the respective said lumbar load is close to the respective said threshold lumbar load limit, while not exceeding the respective said threshold lumbar load limit;
wherein one said operating fuse load rating corresponds to a 5^{th} percentile female;
wherein one said operating fuse load rating corresponds to a 50^{th} percentile male;
wherein one said operating fuse load rating corresponds to a 95^{th} percentile male;
comprising a plurality of operating fuse ratings, wherein each said operating fuse load rating corresponds to a different range of weights between a 5^{th} percentile female and a 95^{th} percentile male;
comprising a plurality of operating fuse ratings, wherein each said operating fuse load rating corresponds to a different range of weights between a 5^{th} percentile female and a 95^{th} percentile male, and, wherein a first said range of weights corresponds to a range between 5^{th} percentile female and a 50^{th} percentile male, and wherein a second said range of weights corresponds to a range between 50^{th} percentile male and a 95^{th} percentile male;
comprising a plurality of operating fuse ratings, wherein each said operating fuse load rating corresponds to a different range of weights between a 5^{th} percentile female and a 95^{th} percentile male and, wherein a first said range of weights corresponds to a range between 5^{th} percentile female and a 40^{th} percentile male, wherein a second said range of weights corresponds to a range between 40^{th} percentile male and a 60^{th} percentile male, and wherein a third said range of weights corresponds to a range between 60^{th} percentile male and a 95^{th} percentile male;
wherein the fuse system has a respective said operating fuse load rating that corresponds to the summation of the fixed loads of the specific fuse elements that are engaged to the bucket and the stationary base via the engagement element.

45. The energy attenuation system according to claim 42, including one of the following:
wherein the engagement element is movable between a plurality of successive positions, including a retracted position and an extended position via a plurality of intermediate positions, wherein in the retracted position the engagement element is not engaged with any said fuse elements, wherein in the extended position the engagement element is engaged with all said fuse elements, and wherein each said intermediate position comprises one said fuse element group, and wherein in each successive intermediate position from the retracted position to the extended position the engagement element is engaged with an increasing number of said fuse elements;
wherein the engagement element is movable between a plurality of successive positions, including a retracted position and an extended position via a plurality of intermediate positions, wherein in the retracted position the engagement element is not engaged with any said fuse elements, wherein in the extended position the engagement element is engaged with all said fuse elements, and wherein each said intermediate position comprises one said fuse element group, and wherein in each successive intermediate position from the retracted position to the extended position the engagement element is engaged with an increasing number of said fuse elements, and, wherein said engagement element comprises a rod member having a free first longitudinal end, and a second longitudinal end that carries a graspable knob, wherein said rod member is movably mounted to the bucket;
wherein the engagement element is movable between a plurality of successive positions, including a retracted position and an extended position via a plurality of intermediate positions, wherein in the retracted position the engagement element is not engaged with any said fuse elements, wherein in the extended position the engagement element is engaged with all said fuse elements, and wherein each said intermediate position comprises one said fuse element group, and wherein in each successive intermediate position from the retracted position to the extended position the engagement element is engaged with an increasing number of said fuse elements, and, wherein said engagement element comprises a rod member having a free first longitudinal end, and a second longitudinal end that carries a graspable knob, wherein said rod member is movably mounted to the bucket, and, wherein the second fuse ends of the fuse elements each comprise a respective lumen, and wherein said lumens are serially and co-axially aligned with one another along an engagement axis;
wherein the engagement element is movable between a plurality of successive positions, including a retracted position and an extended position via a plurality of intermediate positions, wherein in the retracted position the engagement element is not engaged with any said fuse elements, wherein in the extended position the engagement element is engaged with all said fuse elements, and wherein each said intermediate position comprises one said fuse element group, and wherein in each successive intermediate position from the retracted position to the extended position the engagement element is engaged with an increasing number of said fuse elements, and, wherein said engagement element comprises a rod member having a free first longitudinal end, and a second longitudinal end that carries a graspable knob, wherein said rod member is movably mounted to the bucket, and, wherein the second fuse ends of the fuse elements each comprise a respective lumen, and wherein said lumens are serially and co-axially aligned with one another along an engagement axis, and, wherein said lumens have respective cross-sections having a size and shape complementary to a cross-section of the rod member, such that when the rod member passes through each said lumen load bearing contact is established between the respective lumen and the rod member;
wherein at a first said position, the respective said operating fuse load rating corresponds to a 5^{th} percentile female, wherein at a second said position the respective said operating fuse load rating corresponds to a 50^{th} percentile male, and wherein at a third said position the respective said operating fuse load rating corresponds to a 95^{th} percentile male.

46. The energy attenuation system according to claim 42, wherein the engagement element is movable between at least three positions, wherein each said position comprises a different said fuse element group, and wherein in each said position the engagement element engages exclusively with the fuse element group comprised at the respective said position.

47. The energy attenuation system according to claim 46, wherein the fuse system has a respective said operating fuse load rating at each said position correlated with an occupant weight.

48. The energy attenuation system according to claim 47, wherein at a first said position, the respective said operating fuse load rating corresponds to a 5^{th} percentile female, wherein at a second said position the respective said operating fuse load rating corresponds to a 50^{th} percentile male, and wherein at a third said position the respective said operating fuse load rating corresponds to a 95^{th} percentile male.

49. The energy attenuation system according to claim 48, wherein at a first said position, the respective said operating fuse load rating corresponds to a first range between a 5^{th} percentile female and a 95^{th} percentile male, wherein at a second said position the respective said operating fuse load rating corresponds to a second range between a 5^{th} percentile female and a 95^{th} percentile male, and wherein at a third said position the respective said operating fuse load rating corresponds to a third range between a 5^{th} percentile female and a 95^{th} percentile male.

50. The energy attenuation system according to claim 49, wherein said first range corresponds to a range between 5^{th} percentile female and a 40^{th} percentile male, wherein said second range corresponds to a range between 40^{th} percentile male and a 60^{th} percentile male, and wherein said third range corresponds to a range between 60^{th} percentile male and a 95^{th} percentile male.

51. The energy attenuation system according to claim 42, wherein each said corresponding predetermined fixed load is a respective tensile load, and wherein each said fuse element is configured for supporting a respective tensile load up to said corresponding predetermined fixed load.

52. The energy attenuation system according to claim 51, wherein each fuse element is generally flat, having a waisted section intermediate the first fuse end and the second fuse end.

53. The energy attenuation system according to claim 52, wherein at least one said fuse element group comprises two or more said fuse elements juxtaposed with respect to one another, wherein the respective said first fuse ends are aligned with one another, and wherein the respective said second fuse ends are aligned with respect to one another.

54. The energy attenuation system according to claim 42, wherein each said corresponding predetermined fixed load is a respective shear load, and wherein each said fuse element is configured for supporting a respective shear load up to said corresponding predetermined fixed load.

55. The energy attenuation system according to claim 42, wherein each said corresponding predetermined fixed load is a respective torsional load, and wherein each said fuse element is configured for supporting a respective torsional load up to said corresponding predetermined fixed load.

56. A seating system comprising the energy attenuation system according to claim 42, the seating system having the bucket and the frame, wherein the engagement element is secured to one of the bucket and the frame, and the respective said first fuse ends of all the fuse elements are secured to the other one of the bucket and the frame.

57. The seating system according to claim 56, further comprising a checking system configured for checking whether the fuse system has been correctly set for the weight of the occupant.

58. The seating system according to claim 57, including one of the following:
wherein the checking system comprises a weight sensor and a positional sensor, wherein the weight sensor is coupled to the bucket and configured for determining the weight of the occupant when seated on the seat, and wherein the positional sensor is configured for determining the actual position of the engagement element with respect to the position of the engagement element;
wherein the checking system comprises a weight sensor and a positional sensor, wherein the weight sensor is coupled to the bucket and configured for determining the weight of the occupant when seated on the seat, and wherein the positional sensor is configured for determining the actual position of the engagement element with respect to the position of the engagement element, and further comprising a control module operatively coupled to the positional sensor and the weight sensor, and wherein the control module is configured for comparing a weight of the occupant, as determined by the weight sensor with a position of the engagement element, as determined by the positional sensor, and for determining whether the position of the engagement element corresponds to the weight of the occupant.

59. The seating system according to claim 56, including one of the following:
wherein the control module includes a memory with a truth table providing pairs of values for the weight and position that are consistent with one another;
wherein the control module is configured for generating a first observable signal when the position of the engagement element corresponds to the weight of the occupant;
wherein the control module is configured for generating a first observable signal when the position of the engagement element corresponds to the weight of the occupant, and, wherein said first observable signal is in the form of a lit green light;
wherein the control module is configured for generating a second observable signal when the position of the engagement element does not correspond to the weight of the occupant;
wherein the control module is configured for generating a second observable signal when the position of the engagement element does not correspond to the weight of the occupant, and, wherein said first observable signal is in the form of a lit red light.

60. A fuse system configured for coupling to an energy attenuation system for a seating system having a bucket and a frame, the energy attenuation system including at least one energy attenuation component operatively coupled with a fuse system, the fuse system comprising:
a plurality of fuse elements and an engagement element, wherein;
each said fuse element is configured for breaking under a corresponding predetermined fixed load;
each said fuse element comprises a respective first fuse end and a respective second fuse end;
the engagement element is movable with respect to the fuse elements and selectively engageable with any desired number of said fuse elements via the respective said second fuse ends;
the engagement element is configured for being secured to one of the bucket and the frame, and the respective said first fuse ends of all the fuse elements are configured for being secured to the other one of the bucket and the frame.

61. A method for operating a seating system, the seating system being as defined in claim 56, comprising:
engaging the engagement element with a desired said group of fuse elements, corresponding to a weight of an occupant, and allowing the occupant to be accommodated by the seating system.
